(19) United States
(12) Patent Application Publication
(10) Pub. No.: US 2025/0386108 A1
(43) Pub. Date: Dec. 18, 2025

(54) OPTICAL ARRANGEMENTS FOR FOVEATED SENSING

(71) Applicant: QUALCOMM Incorporated, San Diego, CA (US)

(72) Inventors: Rohit RANGANATHAN, Hyderabad (IN); Pawan Kumar BAHETI, Bangalore (IN)

(21) Appl. No.: 18/741,671

(22) Filed: Jun. 12, 2024

(51) Int. Cl. H04N 23/951; H04N 23/55; H04N 25/13; H04N 25/46

(52) U.S. Cl. CPC H04N 23/951; H04N 23/55; H04N 25/135; H04N 25/46

(57) ABSTRACT

Systems and techniques are provided for foveated sensing. For example, a process can include obtaining, from a first image sensor, a first image of a scene. The first image includes a full region including a fovea region and a peripheral region. The first image sensor is associated with a first spatial resolution. The process can include obtaining, from a second image sensor, a second image of the scene. The second image includes the fovea region. The second image sensor is associated with a second spatial resolution different from the first spatial resolution. The process can include generating a combined image. The combined image includes a first plurality of pixels associated with the fovea region of the scene and a second plurality of pixels associated with associated with a peripheral region of the scene. The second plurality of pixels is generated from pixel values of the first image.

### FIELD

The present disclosure relates to systems and techniques for providing optical arrangements for foveated sensing.

### BACKGROUND

A camera can receive light and capture image frames, such as still images or video frames, using an image sensor. Cameras can be configured with a variety of image-capture settings and/or image-processing settings to alter the appearance of images captured thereby. Image-capture settings may be determined and applied before and/or while an image is captured, such as ISO, exposure time (also referred to as exposure, exposure duration, or shutter speed), aperture size, (also referred to as f/stop), focus, and gain (including analog and/or digital gain), among others. Moreover, image-processing settings can be configured for post-processing of an image, such as alterations to contrast, brightness, saturation, sharpness, levels, curves, and colors, among others.

### SUMMARY

According to at least one illustrative example, a method for foveated sensing is provided. The method includes: obtaining, from a first image sensor, a first image of a scene, wherein the first image comprises a full region including a fovea region and a peripheral region, the peripheral region being different than the fovea region, wherein the first image sensor is associated with a first spatial resolution, obtaining, from a second image sensor, a second image of the scene, wherein the second image comprises the fovea region and wherein the second image sensor is associated with a second spatial resolution, the second spatial resolution being different from the first spatial resolution, and generating a combined image, wherein the combined image comprises a first plurality of pixels associated with the fovea region of the scene and a second plurality of pixels associated with associated with a peripheral region of the scene, wherein the second plurality of pixels is generated from pixel values of the first image.

In another example, an apparatus for foveated sensing is provided that includes at least one memory and at least one processor (e.g., implemented in circuitry) coupled to the at least one memory. The apparatus includes a first image sensor and a first optical system aligned relative to a first optical axis and a second image sensor and a second optical system aligned relative to a second optical axis, the second optical axis being different from the first optical axis, wherein the first optical system is associated with a first spatial resolution that is different from a second spatial resolution associated with the second optical system. The at least one processor is configured to and can: obtain, from the first image sensor, a first image of a scene, wherein the first image comprises a full region including a fovea region and a peripheral region, the peripheral region being different than the fovea region; obtain, from the second image sensor, a second image of the scene, wherein the second image comprises the fovea region; and generate a combined image, wherein the combined image comprises a first plurality of pixels associated with the fovea region of the scene and a second plurality of pixels associated with associated with a peripheral region of the scene, wherein the second plurality of pixels is generated from pixel values of the first image.

In another example, a non-transitory computer-readable medium is provided that has stored thereon instructions that, when executed by at least one processor, cause the at least one processor to: obtain, from a first image sensor, a first image of a scene, wherein the first image comprises a full region including a fovea region and a peripheral region, the peripheral region being different than the fovea region, wherein the first image sensor is associated with a first spatial resolution, obtain, from a second image sensor, a second image of the scene, wherein the second image comprises the fovea region and wherein the second image sensor is associated with a second spatial resolution, the second spatial resolution being different from the first spatial resolution, and generate a combined image, wherein the combined image comprises a first plurality of pixels associated with the fovea region of the scene and a second plurality of pixels associated with associated with a peripheral region of the scene, wherein the second plurality of pixels is generated from pixel values of the first image.

In accordance with another embodiment of the present disclosure, an apparatus for foveated sensing is provided. The apparatus includes: means for obtaining, from a first image sensor, a first image of a scene, wherein the first image comprises a full region including a fovea region and a peripheral region, the peripheral region being different than the fovea region, wherein the first image sensor is associated with a first spatial resolution; means for obtaining, from a second image sensor, a second image of the scene, wherein the second image comprises the fovea region and wherein the second image sensor is associated with a second spatial resolution, the second spatial resolution being different from the first spatial resolution; and means for generating a combined image, wherein the combined image comprises a first plurality of pixels associated with the fovea region of the scene and a second plurality of pixels associated with associated with a peripheral region of the scene, wherein the second plurality of pixels is generated from pixel values of the first image.

In some aspects, one or more of the apparatuses described herein is or is part of a camera, a mobile device (e.g., a mobile telephone or so-called “smart phone” or other mobile device), a wireless communication device, an extended reality device (e.g., a virtual reality (VR) device, an augmented reality (AR) device, or a mixed reality (MR) device), a wearable device, a personal computer, a laptop computer, a server computer, or other device. In some aspects, the one or more processors include an image signal processor (ISP). In some aspects, the apparatus includes a camera or multiple cameras for capturing one or more images. In some aspects, the apparatus includes an image sensor that captures the image data. In some aspects, the apparatus further includes a display for displaying the image, one or more notifications (e.g., associated with processing of the image), and/or other displayable data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an architecture of an image capture and processing system, in accordance with some examples of the present disclosure;

FIG. 2A is a diagram illustrating an example of a quad color filter array, in accordance with some examples;

FIG. 2B is a diagram illustrating an example of a binning pattern resulting from application of a binning process to the quad color filter array of FIG. 2A, in accordance with some examples;

FIG. 3 is a block diagram illustrating an architecture of an example extended reality (XR) system, in accordance with some examples of the present disclosure;

FIG. 4 is a block diagram illustrating an architecture of a simultaneous localization and mapping (SLAM) device, in accordance with some examples of the present disclosure;

FIG. 5 is a diagram illustrating an example foveated image sensor, in accordance with some examples of the present disclosure;

FIG. 6 is a block diagram illustrating an architecture of an image capture and processing system with an optical arrangement for replicating a foveated sensor, in accordance with some examples of the present disclosure;

FIG. 7A is a diagram illustrating an example full region image sensor, in accordance with some examples of the present disclosure;

FIG. 7B is a diagram of an example fovea region image sensor, in accordance with some examples of the present disclosure;

FIG. 7C is a diagram illustrating the fovea region image sensor of FIG. 7B with an adjusted fovea region, in accordance with some examples of the present disclosure;

FIG. 8 is a diagram illustrating an example optical arrangement for foveated sensing, in accordance with some examples of the present disclosure;

FIG. 9A is a perspective diagram illustrating a head-mounted display (HMD) that performs feature tracking and/or VSLAM, in accordance with some examples of the present disclosure;

FIG. 9B is a perspective diagram illustrating the HMD of FIG. 9A being worn by a user, in accordance with some examples of the present disclosure;

FIG. 10 is a flow diagram illustrating an example of an image processing technique, in accordance with some examples of the present disclosure;

FIG. 11 is a block diagram illustrating an example of a deep learning network, in accordance with some examples;

FIG. 12 is a block diagram illustrating an example of a convolutional neural network, in accordance with some examples;

FIG. 13 is a diagram illustrating an example of a system for implementing certain aspects of the present technology.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Electronic devices (e.g., extended reality (XR) devices such as virtual reality (VR) devices, augmented reality (AR) devices, mixed reality (MR) devices, etc., mobile phones, wearable devices such as smart watches, smart glasses, etc., tablet computers, connected devices, laptop computers, etc.) are increasingly equipped with cameras to capture image frames, such as still images and/or video frames, for consumption. For example, an electronic device can include a camera to allow the electronic device to capture a video or image of a scene, a person, an object, etc. Additionally, cameras themselves are used in a number of configurations (e.g., handheld digital cameras, digital single-lens-reflex (DSLR) cameras, worn camera (including body-mounted cameras and head-borne cameras), stationary cameras (e.g., for security and/or monitoring), vehicle-mounted cameras, etc.).

A camera can receive light and capture image frames (e.g., still images or video frames) using an image sensor (which may include an array of photosensors). In some examples, a camera may include one or more processors, such as image signal processors (ISPs), that can process one or more image frames captured by an image sensor. For example, a raw image frame captured by an image sensor can be processed by an ISP of a camera to generate a final image. In some cases, a camera, or an electronic device implementing a camera, can further process a captured image or video for certain effects (e.g., compression, image enhancement, image restoration, scaling, framerate conversion, etc.) and/or certain applications such as computer vision, extended reality (e.g., augmented reality, virtual reality, and the like), object detection, image recognition (e.g., face recognition, object recognition, scene recognition, etc.), feature extraction, authentication, and automation, among others.

Cameras can be configured with a variety of image-capture settings and/or image-processing settings to alter the appearance of an image. Image-capture settings can be determined and applied before or while an image is captured, such as ISO, exposure time (also referred to as exposure, exposure duration, and/or shutter speed), aperture size (also referred to as f/stop), focus, and gain, among others. Image-processing settings can be configured for post-processing of an image, such as alterations to a contrast, brightness, saturation, sharpness, levels, curves, and colors, among others.

An XR device (e.g., a VR headset or head-mounted display (HMD), an AR headset or HMD, etc.) can output high fidelity images at high resolution and at high frame rates. In XR environments, users are transported into digital worlds where their senses are fully engaged and smooth motion is essential to prevent motion sickness and disorientation, which are common issues experienced at lower frame rates. By displaying images at a high frame rate, typically 90 frames per second (FPS) or above, XR devices can minimize latency and maintain synchronization between the user movements and the visual feedback. Higher frame rates result in a more realistic and comfortable experience and ensure that human neural processing is engaged within the XR environment. Otherwise, the disconnect between the XR environment and the visual feedback received by the user creates motion sickness, disorientation, and nausea.

One application of XR devices is visual see-through (VST), which refers to the capability of XR devices, such as AR glasses or MR headsets, to overlay digital content seamlessly onto the user's real-world view. VST technology enables users to see and interact with their physical surroundings while augmenting them with virtual elements. By tracking the user's head movements and adjusting the position of digital content accordingly, VST technology ensures that virtual objects appear anchored to the real world, creating a convincing and integrated mixed reality experience.

Capturing images with varying resolutions and/or at varying frames rates can lead to a large amount of power consumption and bandwidth usage for systems and devices. For instance, a 16 megapixel (MP) or 20 MP image sensor capturing frames at 90 FPS can require 5.1 to 6.8 Gigabits per second (Gbps) of additional bandwidth. However, such a large amount of bandwidth may not be available on certain devices (e.g., XR devices).

Foveation is a process for varying detail in an image based on the fovea (e.g., the center of the eye's retina) that can identify salient parts of a scene (e.g., a fovea region) and peripheral parts of the scene (e.g., a peripheral region). In some aspects, a foveated image sensor can be configured to capture a part of a frame in high resolution, which is referred to as a foveated region or a region of interest (ROI), and other parts of the frame at a lower resolution using various techniques (e.g., pixel binning), which is referred to as a peripheral region. In some aspects, an image signal processor can process a foveated region or ROI at a higher resolution and a peripheral region at a lower resolution. In either of such aspects, the image sensor and/or the image signal processor (ISP) can produce high-resolution output for a foveated region where the user is focusing (or is likely to focus) and can produce a low-resolution output (e.g., a binned output) for the peripheral region.

In some implementations, an ISP can control frame rates for which an image sensor captures various regions (e.g., fovea regions, peripheral regions, etc.) of a field of view (FOV) of the image sensor. For instance, various designs for foveated sensors send a full field of view FOV of an image sensor along with the fovea ROI(s) at same FPS (e.g., at a high FPS such as 60 FPS or 120 FPS) required for a particular application (e.g., for VST XR applications). However, every fovea or full FOV may not need a high FPS at all times. For example, with a steady gaze in a relatively static scene, the peripheral (e.g., full FOV) and in some cases the foveal ROI can be captured at a lower FPS.

In some cases, a foveated image sensor can include a peripheral region with a fovea region. The disclosed systems and techniques enable an XR system to have sufficient bandwidth to enable applications (e.g., VST applications) that use high-quality frames or images (e.g., high-definition (HD) images or video) and synthesize the high-quality frames or images with generated content, thereby creating mixed reality content. The terms frames and images are used herein interchangeably.

Foveated image sensors can provide many benefits (e.g., power savings, reduced computational burden, reduced memory requirements, etc.). However, many devices may not include foveated image sensors. In addition, some foveated image sensors may be limited to fixed fovea region(s) and fixed peripheral region(s). In some examples, a particular scene may include multiple salient regions that cannot be captured simultaneously by the fixed fovea region(s) simultaneously. In such an example, one or more salient regions may be captured with a lower resolution, FPS, or the like as a result of the fixed fovea region(s). Accordingly, systems and techniques are needed for providing benefits of foveated image sensors in systems that may not include a foveated image sensors. In some cases, systems and techniques are needed for providing adjustable fovea regions.

Systems and techniques are described herein for providing optical arrangements for replicating foveated image sensors. In some examples, the systems and techniques described herein include utilizing a beam splitter to direct light from a scene to two or more image sensors. In some cases, at least one full region image sensor can be provided for capturing a full region of capture of a scene. In some examples, at least one fovea image sensor can be provided for capturing a fovea region. In some implementations, the fovea region can overlap with the full region of capture of the scene. In some examples, the fovea region can be fully contained within the full region of capture of the scene. In some cases, a size of the fovea region can be adjusted by adjusting a zoom of a lens system associated with the at least one fovea image sensor. In some cases, a size of the portion of a scene captured by the at least one full region image sensor can be adjusted by adjusting a zoom of a lens system associated with the at least one full region image sensor.

In some implementations, images captured by the at least one fovea image sensor can be processed by a first image sensor processor (ISP). In some cases, a full region image captured by the at least one full region image sensor can be processed by a second ISP. In some cases, a post-processing engine (e.g., a CPU, GPU, or the like) can combine a fovea image captured by the at least one fovea image sensor and an image captured by the at least one full region image sensor to generate a combined image. In one illustrative example, a post-processing engine can combine (e.g., blend, fuse, etc.) the full region image and the fovea image. In some implementations, a full resolution fovea image can be combined with upscaled pixels from a peripheral region (e.g., outside of the fovea region) of the full region image to generate a full region image with enhanced image quality. In some examples, upscaled pixels from the peripheral region of the full region image and the full resolution fovea image may be blended to reduce visual artifacts. For example, blending the upscaled pixels from the peripheral region of the full region image and the full resolution fovea image may include blending of pixels near a border between the upscaled pixels from the peripheral region of the full region image and pixels corresponding to full resolution fovea image.

In some implementations, a single ISP may be used to process images from both the at least one fovea image sensor and the at least one full region image sensor. In some aspects, the at least one fovea image sensor and the at least one full region image sensor may capture non-concentric portions of a scene (e.g., offset image sensors without a beam splitter) and the post-processing engine can combine the full region image and the fovea image. In some aspects, at least one of the full region image or the fovea image may be warped to align the images.

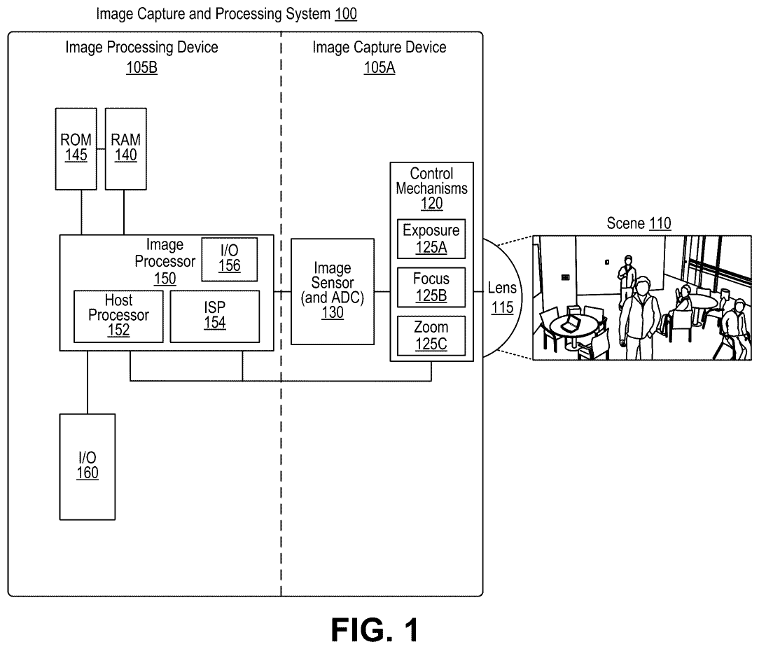

Various aspects of the application will be described with respect to the figures. FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, high dynamic range (HDR), depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting May be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image capture and processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode.

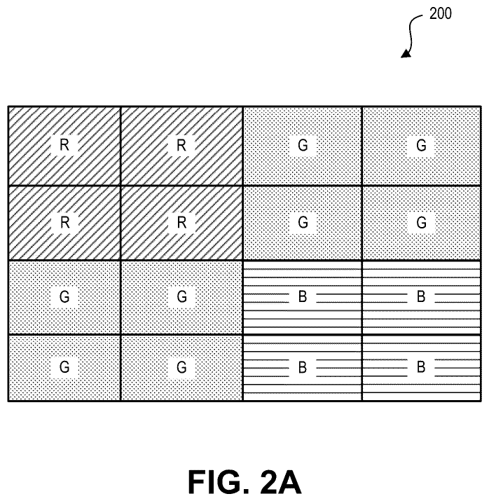

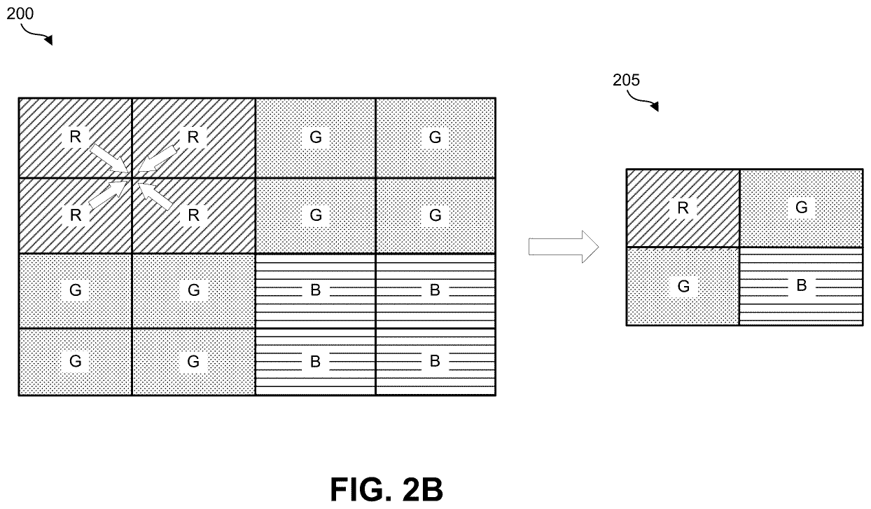

Various color filter arrays can be used, including a Bayer color filter array, a quad color filter array (also referred to as a quad Bayer color filter array or QCFA), and/or any other color filter array. FIG. 2A is a diagram illustrating an example of a quad color filter array 200. As shown, the quad color filter array 200 includes a 2×2 (or “quad”) pattern of color filters, including a 2×2 pattern of red (R) color filters, a pair of 2×2 patterns of green (G) color filters, and a 2×2 pattern of blue (B) color filters. The pattern of the quad color filter array 200 shown in FIG. 2A is repeated for the entire array of photodiodes of a given image sensor. As shown, the Bayer color filter array includes a repeating pattern of red color filters, blue color filters, and green color filters. Using either quad color filter array or the Bayer color filter array, each pixel of an image is generated based on red light data from at least one photodiode covered in a red color filter of the color filter array, blue light data from at least one photodiode covered in a blue color filter of the color filter array, and green light data from at least one photodiode covered in a green color filter of the color filter array. Other types of color filter arrays may use yellow, magenta, and/or cyan (also referred to as “emerald”) color filters instead of or in addition to red, blue, and/or green color filters. Some image sensors may lack color filters altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for PDAF. In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

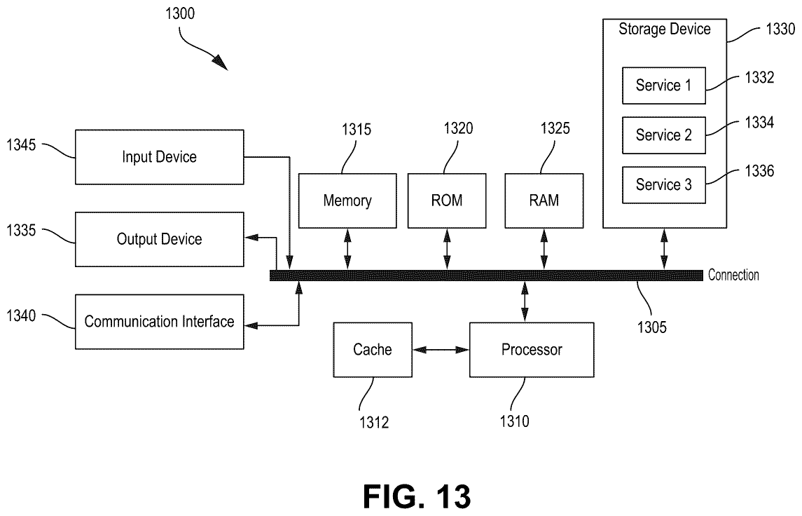

The image processor 150 may include one or more processors, such as one or more ISPs (including ISP 154), one or more host processors (including host processor 152), and/or one or more of any other type of processor 1310 discussed with respect to the computing system 1300 of FIG. 13. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1325, read-only memory (ROM) 145/1320, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1335, any other input devices 1345, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image processing device 105B, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more or fewer components than those shown in FIG. 1. In some cases, the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

As noted above, a color filter array can cover the one or more arrays of photodiodes (or other photosensitive elements) of the image sensor 130. The color filter array can include a quad color filter array in some implementations, such as the quad color filter array 200 shown in FIG. 2A. In certain situations, after an image is captured by the image sensor 130 (e.g., before the image is provided to and processed by the ISP 154), the image sensor 130 can perform a binning process to bin the quad color filter array 200 pattern into a binned Bayer pattern. For instance, as shown in FIG. 2B (described below), the quad color filter array 200 pattern can be converted to a Bayer color filter array pattern (with reduced resolution) by applying the binning process. The binning process can increase signal-to-noise ratio (SNR), resulting in increased sensitivity and reduced noise in the captured image. In one illustrative example, binning can be performed in low-light settings when lighting conditions are poor, which can result in a high quality image with higher brightness characteristics and less noise.

FIG. 2B is a diagram illustrating an example of a binning pattern 205 resulting from application of a binning process to the quad color filter array 200. The example illustrated in FIG. 2B is an example of a binning pattern 205 that results from a 2×2 quad color filter array binning process, where an average of each 2×2 set of pixels in the quad color filter array 200 results in one pixel in the binning pattern 205. For example, an average of the four pixels captured using the 2×2 set of red (R) color filters in the quad color filter array 200 can be determined. The average R value can be used as the single R component in the binning pattern 205. An average can be determined for each 2×2 set of color filters of the quad color filter array 200, including an average of the top-right pair of 2×2 green (G) color filters of the quad color filter array 200 (resulting in the top-right G component in the binning pattern 205), the bottom-left pair of 2×2 G color filters of the quad color filter array 200 (resulting in the bottom-left G component in the binning pattern 205), and the 2×2 set of blue (B) color filters (resulting in the B component in the binning pattern 205) of the quad color filter array 200.

The size of the binning pattern 205 is a quarter of the size of the quad color filter array 200. As a result, a binned image resulting from the binning process is a quarter of the size of an image processed without binning. In one illustrative example where a 48 megapixel (48 MP or 48 M) image is captured by the image sensor 130 using a 2×2 quad color filter array 200, a 2×2 binning process can be performed to generate a 12 MP binned image. The reduced-resolution image can be upsampled (upscaled) to a higher resolution in some cases (e.g., before or after being processed by the ISP 154).

In some examples, when binning is not performed, a quad color filter array pattern can be remosaiced (using a remosaicing process) by the image sensor 130 to a Bayer color filter array pattern. For example, the Bayer color filter array is used in many ISPs. To utilize all ISP modules or filters in such ISPs, a remosaicing process may need to be performed to remosaic from the quad color filter array 200 pattern to the Bayer color filter array pattern. The remosaicing of the quad color filter array 200 pattern to a Bayer color filter array pattern allows an image captured using the quad color filter array 200 to be processed by ISPs that are designed to process images captured using a Bayer color filter array pattern.

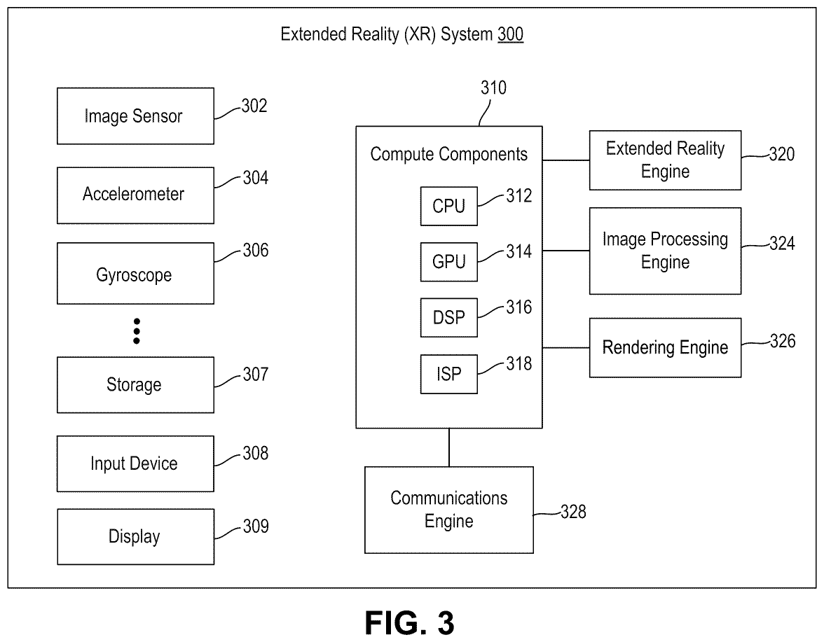

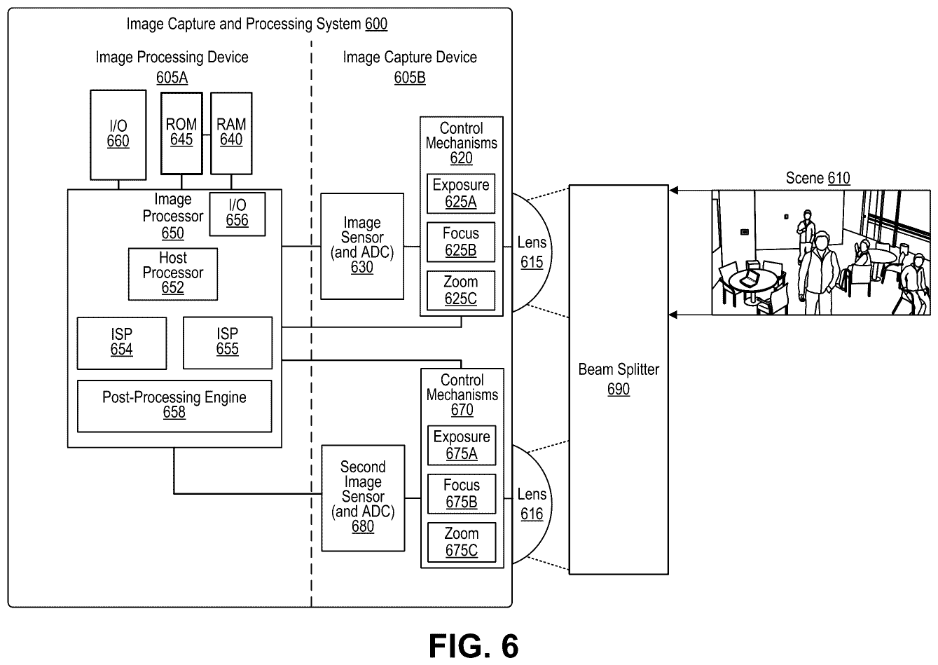

In some examples, the XR system 300 of FIG. 3 can include the image capture and processing system 100, the image capture device 105A, the image processing device 105B, the image capture and processing system 600 of FIG. 6, the image capture device 605A of FIG. 6, the image processing device 605B of FIG. 6 or a combination thereof.

FIG. 3 is a diagram illustrating an architecture of an example XR system 300, in accordance with some aspects of the disclosure. The XR system 300 can run (or execute) XR applications and implement XR operations. In some examples, the XR system 300 can perform tracking and localization, mapping of an environment in the physical world (e.g., a scene), and/or positioning and rendering of virtual content on a display 309 (e.g., a screen, visible plane/region, and/or other display) as part of an XR experience. For example, the XR system 300 can generate a map (e.g., a three-dimensional (3D) map) of an environment in the physical world, track a pose (e.g., location and position) of the XR system 300 relative to the environment (e.g., relative to the 3D map of the environment), position and/or anchor virtual content in a specific location(s) on the map of the environment, and render the virtual content on the display 309 such that the virtual content appears to be at a location in the environment corresponding to the specific location on the map of the scene where the virtual content is positioned and/or anchored. The display 309 can include a glass, a screen, a lens, a projector, and/or other display mechanism that allows a user to see the real-world environment and also allows XR content to be overlaid, overlapped, blended with, or otherwise displayed thereon.

In this illustrative example, the XR system 300 includes one or more image sensors 302, an accelerometer 304, a gyroscope 306, storage 307, compute components 310, an XR engine 320, an image processing engine 324, a rendering engine 326, and a communications engine 328. It should be noted that the components 302-328 shown in FIG. 3 are non-limiting examples provided for illustrative and explanation purposes, and other examples can include more, fewer, and/or different components than those shown in FIG. 3. For example, in some cases, the XR system 300 can include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors. audio sensors, etc.), one or more display devices, one more other processing engines, one or more other hardware components, and/or one or more other software and/or hardware components that are not shown in FIG. 3. While various components of the XR system 300, such as the image sensor 302, may be referenced in the singular form herein, it should be understood that the XR system 300 may include multiple of any component discussed herein (e.g., multiple image sensors 302).

The XR system 300 can include or can be in communication with (wired or wirelessly) an input device 308. The input device 308 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device 1345 discussed herein, or any combination thereof. In some cases, the image sensor 302 can capture images that can be processed for interpreting gesture commands.

The XR system 300 can also communicate with one or more other electronic devices (wired or wirelessly). For example, communications engine 328 can be configured to manage connections and communicate with one or more electronic devices. In some cases, the communications engine 328 can correspond to the communications interface 1340 of FIG. 13.

In some implementations, the one or more image sensors 302, the accelerometer 304, the gyroscope 306, storage 307, compute components 310, XR engine 320, image processing engine 324, rendering engine 326, communications engine 328 and/or any combination thereof can be part of the same computing device. For example, in some cases, the one or more image sensors 302, the accelerometer 304, the gyroscope 306, storage 307, compute components 310, XR engine 320, image processing engine 324, rendering engine 326, communications engine 328 and/or any combination thereof can be integrated into an HMD, extended reality glasses, smartphone, laptop, tablet computer, gaming system, and/or any other computing device. However, in some implementations, the one or more image sensors 302, the accelerometer 304, the gyroscope 306, storage 307, compute components 310, XR engine 320, image processing engine 324, visual alignment engine, rendering engine 326, communications engine 328 and/or any combination thereof can be part of two or more separate computing devices. For example, in some cases, some of the components 302-328 can be part of, or implemented by, one computing device and the remaining components can be part of, or implemented by, one or more other computing devices.

The storage 307 can be any storage device(s) for storing data. Moreover, the storage 307 can store data from any of the components of the XR system 300. For example, the storage 307 can store data from the image sensor 302 (e.g., image or video data), data from the accelerometer 304 (e.g., measurements), data from the gyroscope 306 (e.g., measurements), data from the compute components 310 (e.g., processing parameters, preferences, virtual content, rendering content, scene maps, tracking and localization data, object detection data, privacy data, XR application data, face recognition data, occlusion data, etc.), data from the XR engine 320, data from the image processing engine 324, data from the visual alignment engine (e.g., eye position) and/or data from the rendering engine 326 (e.g., output frames). In some examples, the storage 307 can include a buffer for storing frames for processing by the compute components 310.

The one or more compute components 310 can include a central processing unit (CPU) 312, a graphics processing unit (GPU) 314, a digital signal processor (DSP) 316, an image signal processor (ISP) 318, and/or other processor (e.g., a neural processing unit (NPU) implementing one or more trained neural networks). The compute components 310 can perform various operations such as image enhancement, computer vision, graphics rendering, extended reality operations (e.g., tracking, localization, pose estimation, mapping, content anchoring, content rendering, etc.), image and/or video processing, sensor processing, recognition (e.g., text recognition, facial recognition, object recognition, feature recognition, tracking or pattern recognition, scene recognition, occlusion detection, etc.), trained machine learning operations, filtering, and/or any of the various operations described herein. In some examples, the compute components 310 can implement (e.g., control, operate, etc.) the XR engine 320, the image processing engine 324, the rendering engine 326, the communications engine 328 and/or any combination thereof. In other examples, the compute components 310 can also implement one or more other processing engines.

In some implementations, the image processing engine 324 may include or be included in an image capture and processing system 100, an image capture device 105A, an image processing device 105B, image processor 150, host processor 152, ISP 154, and/or any combination thereof.

The image sensor 302 can include any image and/or video sensors or capturing devices. In some examples, the image sensor 302 can be part of a multiple-camera assembly, such as a dual-camera assembly. The image sensor 302 can capture image and/or video content (e.g., raw image and/or video data), which can then be processed by the compute components 310, the XR engine 320, the image processing engine 324, the rendering engine 326, and/or communications engine 328 as described herein. In some examples, the image sensors 302 may include an image capture and processing system 100, an image capture device 105A, an image processing device 105B, or a combination thereof.

In some examples, the image sensor 302 can capture image data and can generate images (also referred to as frames) based on the image data and/or can provide the image data or frames to the XR engine 320, the image processing engine 324, the rendering engine 326, and/or the communications engine 328 for processing. An image or frame can include a video frame of a video sequence or a still image. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, the image sensor 302 (and/or other camera(s) of the XR system 300) can be configured to also capture depth information. For example, in some implementations, the image sensor 302 (and/or other camera) can include an RGB-depth (RGB-D) camera. In some cases, the XR system 300 can include one or more depth sensors (not shown) that are separate from the image sensor 302 (and/or other camera) and that can capture depth information. For instance, such a depth sensor can obtain depth information independently from the image sensor 302. In some examples, a depth sensor can be physically installed in the same general location as the image sensor 302 but may operate at a different frequency or frame rate from the image sensor 302. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

The XR system 300 can also include other sensors in its one or more sensors. The one or more sensors can include one or more accelerometers (e.g., accelerometer 304), one or more gyroscopes (e.g., gyroscope 306), and/or other sensors. The one or more sensors can provide velocity, orientation, and/or other position-related information to the compute components 310. For example, the accelerometer 304 can detect acceleration by the XR system 300 and can generate acceleration measurements based on the detected acceleration. In some cases, the accelerometer 304 can provide one or more translational vectors (e.g., up/down, left/right, forward/back) that can be used for determining a position or pose of the XR system 300. The gyroscope 306 can detect and measure the orientation and angular velocity of the XR system 300. For example, the gyroscope 306 can be used to measure the pitch, roll, and yaw of the XR system 300. In some cases, the gyroscope 306 can provide one or more rotational vectors (e.g., pitch, yaw, roll). In some examples, the image sensor 302 and/or the XR engine 320 can use measurements obtained by the accelerometer 304 (e.g., one or more translational vectors) and/or the gyroscope 306 (e.g., one or more rotational vectors) to calculate the pose of the XR system 300. As previously noted, in other examples, the XR system 300 can also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of the XR system 300, using a combination of one or more accelerometers, one or more gyroscopes, and/or one or more magnetometers. In some examples, the one or more sensors can output measured information associated with the capture of an image captured by the image sensor 302 (and/or other camera of the XR system 300) and/or depth information obtained using one or more depth sensors of the XR system 300.

The output of one or more sensors (e.g., the accelerometer 304, the gyroscope 306, one or more IMUs, and/or other sensors) can be used by the XR engine 320 to determine a pose of the XR system 300 (also referred to as the head pose) and/or the pose of the image sensor 302 (or other camera of the XR system 300). In some cases, the pose of the XR system 300 and the pose of the image sensor 302 (or other camera) can be the same. The pose of image sensor 302 refers to the position and orientation of the image sensor 302 relative to a frame of reference (e.g., with respect to the scene 110). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees Of Freedom (3DoF), which refers to the three angular components (e.g., roll, pitch, and yaw).

In some cases, a device tracker (not shown) can use the measurements from the one or more sensors and image data from the image sensor 302 to track a pose (e.g., a 6DoF pose) of the XR system 300. For example, the device tracker can fuse visual data (e.g., using a visual tracking solution) from the image data with inertial data from the measurements to determine a position and motion of the XR system 300 relative to the physical world (e.g., the scene) and a map of the physical world. As described below, in some examples, when tracking the pose of the XR system 300, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of the XR system 300 within the scene and the 3D map of the scene, etc. The 3D map can provide a digital representation of a scene in the real/physical world. In some examples, the 3D map can anchor location-based objects and/or content to real-world coordinates and/or objects. The XR system 300 can use a mapped scene (e.g., a scene in the physical world represented by, and/or associated with, a 3D map) to merge the physical and virtual worlds and/or merge virtual content or objects with the physical environment.

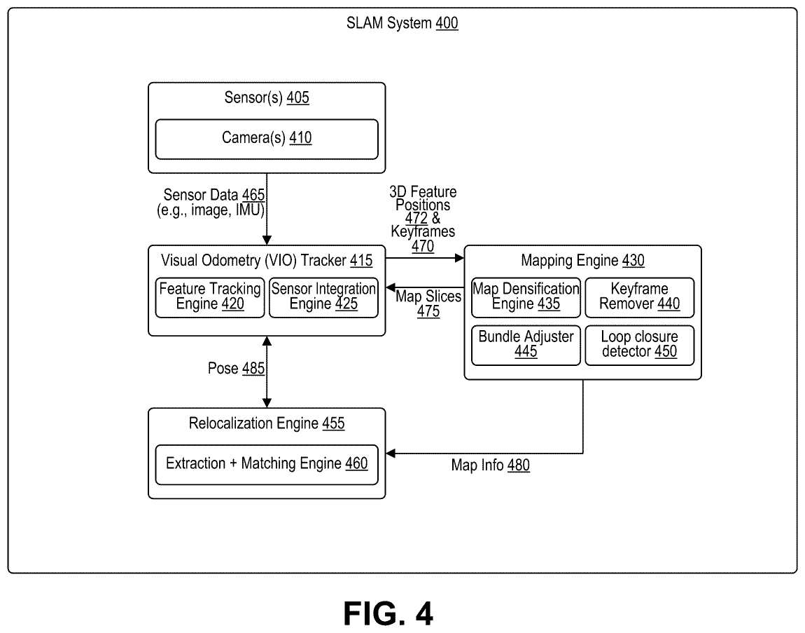

In some aspects, the pose of image sensor 302 and/or the XR system 300 as a whole can be determined and/or tracked by the compute components 310 using a visual tracking solution based on images captured by the image sensor 302 (and/or other camera of the XR system 300). For instance, in some examples, the compute components 310 can perform tracking using computer vision-based tracking, model-based tracking, and/or SLAM techniques. For instance, the compute components 310 can perform SLAM or can be in communication (wired or wireless) with a SLAM system (not shown), such as the SLAM system 400 of FIG. 4. SLAM refers to a class of techniques where a map of an environment (e.g., a map of an environment being modeled by XR system 300) is created while simultaneously tracking the pose of a camera (e.g., image sensor 302) and/or the XR system 300 relative to that map. The map can be referred to as a SLAM map and can be three-dimensional (3D). The SLAM techniques can be performed using color or grayscale image data captured by the image sensor 302 (and/or other camera of the XR system 300) and can be used to generate estimates of 6DoF pose measurements of the image sensor 302 and/or the XR system 300. Such a SLAM technique configured to perform 6DoF tracking can be referred to as 6DoF SLAM. In some cases, the output of the one or more sensors (e.g., the accelerometer 304, the gyroscope 306, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 302 (and/or other camera) to the SLAM map. For example, 6DoF SLAM can use feature point associations from an input image to determine the pose (position and orientation) of the image sensor 302 and/or XR system 300 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 302 and/or the XR system 300 can be determined by projecting features from the 3D SLAM map into an image or video frame and updating the camera pose from verified 2D-3D correspondences.

In one illustrative example, the compute components 310 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

In some cases, the XR system 300 can also track the hand and/or fingers of the user to allow the user to interact with and/or control virtual content in a virtual environment. For example, the XR system 300 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

FIG. 4 is a block diagram illustrating an architecture of a SLAM system 400. In some examples, the SLAM system 400 can be, or can include, an XR system, such as the XR system 300 of FIG. 3. In some examples, the SLAM system 400 can be a wireless communication device, a mobile device or handset (e.g., a mobile telephone or so-called “smart phone” or other mobile device), a wearable device, a personal computer, a laptop computer, a server computer, a portable video game console, a portable media player, a camera device, a manned or unmanned ground vehicle, a manned or unmanned aerial vehicle, a manned or unmanned aquatic vehicle, a manned or unmanned underwater vehicle, a manned or unmanned vehicle, an autonomous vehicle, a vehicle, a computing system of a vehicle, a robot, another device, or any combination thereof.

The SLAM system 400 of FIG. 4 includes, or is coupled to, each of one or more sensors 405. The one or more sensors 405 can include one or more cameras 410. Each of the one or more cameras 410 may include an image capture device 105A, an image processing device 105B, an image capture and processing system 100, another type of camera, or a combination thereof. Each of the one or more cameras 410 may be responsive to light from a particular spectrum of light. The spectrum of light may be a subset of the electromagnetic (EM) spectrum. For example, each of the one or more cameras 410 may be a visible light (VL) camera responsive to a VL spectrum, an infrared (IR) camera responsive to an IR spectrum, an ultraviolet (UV) camera responsive to a UV spectrum, a camera responsive to light from another spectrum of light from another portion of the electromagnetic spectrum, or a some combination thereof.

The one or more sensors 405 can include one or more other types of sensors other than cameras 410, such as one or more of each of: accelerometers, gyroscopes, magnetometers, inertial measurement units (IMUs), altimeters, barometers, thermometers, radio detection and ranging (RADAR) sensors, light detection and ranging (LIDAR) sensors, sound navigation and ranging (SONAR) sensors, sound detection and ranging (SODAR) sensors, global navigation satellite system (GNSS) receivers, global positioning system (GPS) receivers, BeiDou navigation satellite system (BDS) receivers, Galileo receivers, Globalnaya Navigazionnaya Sputnikovaya Sistema (GLONASS) receivers, Navigation Indian Constellation (NavIC) receivers, Quasi-Zenith Satellite System (QZSS) receivers, Wi-Fi positioning system (WPS) receivers, cellular network positioning system receivers, Bluetooth® beacon positioning receivers, short-range wireless beacon positioning receivers, personal area network (PAN) positioning receivers, wide area network (WAN) positioning receivers, wireless local area network (WLAN) positioning receivers, other types of positioning receivers, other types of sensors discussed herein, or combinations thereof. In some examples, the one or more sensors 405 can include any combination of sensors of the XR system 300 of FIG. 3.

The SLAM system 400 of FIG. 4 includes a visual-inertial odometry (VIO) tracker 415. The term visual-inertial odometry may also be referred to herein as visual odometry. The VIO tracker 415 receives sensor data 465 from the one or more sensors 405. For instance, the sensor data 465 can include one or more images captured by the one or more cameras 410. The sensor data 465 can include other types of sensor data from the one or more sensors 405, such as data from any of the types of sensors 405 listed herein. For instance, the sensor data 465 can include inertial measurement unit (IMU) data from one or more IMUs of the one or more sensors 405.

Upon receipt of the sensor data 465 from the one or more sensors 405, the VIO tracker 415 performs feature detection, extraction, and/or tracking using a feature tracking engine 420 of the VIO tracker 415. For instance, where the sensor data 465 includes one or more images captured by the one or more cameras 410 of the SLAM system 400, the VIO tracker 415 can identify, detect, and/or extract features in each image. Features may include visually distinctive points in an image, such as portions of the image depicting edges and/or corners. The VIO tracker 415 can receive sensor data 465 periodically and/or continually from the one or more sensors 405, for instance by continuing to receive more images from the one or more cameras 410 as the one or more cameras 410 capture a video, where the images are video frames of the video. The VIO tracker 415 can generate descriptors for the features. Feature descriptors can be generated at least in part by generating a description of the feature as depicted in a local image patch extracted around the feature. In some examples, a feature descriptor can describe a feature as a collection of one or more feature vectors. The VIO tracker 415, in some cases with the mapping engine 430 and/or the relocalization engine 455, can associate the plurality of features with a map of the environment based on such feature descriptors. The feature tracking engine 420 of the VIO tracker 415 can perform feature tracking by recognizing features in each image that the VIO tracker 415 already previously recognized in one or more previous images, in some cases based on identifying features with matching feature descriptors in different images. The feature tracking engine 420 can track changes in one or more positions at which the feature is depicted in each of the different images. For example, the feature extraction engine can detect a particular corner of a room depicted in a left side of a first image captured by a first camera of the cameras 410. The feature extraction engine can detect the same feature (e.g., the same particular corner of the same room) depicted in a right side of a second image captured by the first camera. The feature tracking engine 420 can recognize that the features detected in the first image and the second image are two depictions of the same feature (e.g., the same particular corner of the same room), and that the feature appears in two different positions in the two images. The VIO tracker 415 can determine, based on the same feature appearing on the left side of the first image and on the right side of the second image that the first camera has moved, for example if the feature (e.g., the particular corner of the room) depicts a static portion of the environment.

The VIO tracker 415 can include a sensor integration engine 425. The sensor integration engine 425 can use sensor data from other types of sensors 405 (other than the cameras 410) to determine information that can be used by the feature tracking engine 420 when performing the feature tracking. For example, the sensor integration engine 425 can receive IMU data (e.g., which can be included as part of the sensor data 465) from an IMU of the one or more sensors 405. The sensor integration engine 425 can determine, based on the IMU data in the sensor data 465, that the SLAM system 400 has rotated 15 degrees in a clockwise direction from acquisition or capture of a first image to acquisition or capture of the second image by a first camera of the cameras 410. Based on this determination, the sensor integration engine 425 can identify that a feature depicted at a first position in the first image is expected to appear at a second position in the second image, and that the second position is expected to be located to the left of the first position by a predetermined distance (e.g., a predetermined number of pixels, inches, centimeters, millimeters, or another distance metric). The feature tracking engine 420 can take this expectation into consideration in tracking features between the first image and the second image.

Based on the feature tracking by the feature tracking engine 420 and/or the sensor integration by the sensor integration engine 425, the VIO tracker 415 can determine a 3D feature positions 472 of a particular feature. The 3D feature positions 472 can include one or more 3D feature positions and can also be referred to as 3D feature points. The 3D feature positions 472 can be a set of coordinates along three different axes that are perpendicular to one another, such as an X coordinate along an X axis (e.g., in a horizontal direction), a Y coordinate along a Y axis (e.g., in a vertical direction) that is perpendicular to the X axis, and a Z coordinate along a Z axis (e.g., in a depth direction) that is perpendicular to both the X axis and the Y axis. The VIO tracker 415 can also determine one or more keyframes 470 (referred to hereinafter as keyframes 470) corresponding to the particular feature. In some examples, a keyframe (from the one or more keyframes 470) corresponding to a particular feature may be an image in which the particular feature is clearly depicted. In some examples, a keyframe corresponding to a particular feature may be an image that reduces uncertainty in the 3D feature positions 472 of the particular feature when considered by the feature tracking engine 420 and/or the sensor integration engine 425 for determination of the 3D feature positions 472. In some examples, a keyframe corresponding to a particular feature also includes data about the pose 485 of the SLAM system 400 and/or the camera(s) 410 during capture of the keyframe. In some examples, the VIO tracker 415 can send 3D feature positions 472 and/or keyframes 470 corresponding to one or more features to the mapping engine 430. In some examples, the VIO tracker 415 can receive map slices 475 from the mapping engine 430. The VIO tracker 415 can extract feature information within the map slices 475 for feature tracking using the feature tracking engine 420.

Based on the feature tracking by the feature tracking engine 420 and/or the sensor integration by the sensor integration engine 425, the VIO tracker 415 can determine a pose 485 of the SLAM system 400 and/or of the cameras 410 during capture of each of the images in the sensor data 465. The pose 485 can include a location of the SLAM system 400 and/or of the cameras 410 in 3D space, such as a set of coordinates along three different axes that are perpendicular to one another (e.g., an X coordinate, a Y coordinate, and a Z coordinate). The pose 485 can include an orientation of the SLAM system 400 and/or of the cameras 410 in 3D space, such as pitch, roll, yaw, or some combination thereof. In some examples, the VIO tracker 415 can send the pose 485 to the relocalization engine 455. In some examples, the VIO tracker 415 can receive the pose 485 from the relocalization engine 455.

The SLAM system 400 also includes a mapping engine 430. The mapping engine 430 generates a 3D map of the environment based on the 3D feature positions 472 and/or the keyframes 470 received from the VIO tracker 415. The mapping engine 430 can include a map densification engine 435, a keyframe remover 440, a bundle adjuster 445, and/or a loop closure detector 450. The map densification engine 435 can perform map densification, in some examples, increase the quantity and/or density of 3D coordinates describing the map geometry. The keyframe remover 440 can remove keyframes, and/or in some cases add keyframes. In some examples, the keyframe remover 440 can remove keyframes 470 corresponding to a region of the map that is to be updated and/or whose corresponding confidence values are low. The bundle adjuster 445 can, in some examples, refine the 3D coordinates describing the scene geometry, parameters of relative motion, and/or optical characteristics of the image sensor used to generate the frames, according to an optimality criterion involving the corresponding image projections of all points. The loop closure detector 450 can recognize when the SLAM system 400 has returned to a previously mapped region and can use such information to update a map slice and/or reduce the uncertainty in certain 3D feature points or other points in the map geometry. The mapping engine 430 can output map slices 475 to the VIO tracker 415. The map slices 475 can represent 3D portions or subsets of the map. The map slices 475 can include map slices 475 that represent new, previously unmapped areas of the map. The map slices 475 can include map slices 475 that represent updates (or modifications or revisions) to previously mapped areas of the map. The mapping engine 430 can output map information 480 to the relocalization engine 455. The map information 480 can include at least a portion of the map generated by the mapping engine 430. The map information 480 can include one or more 3D points making up the geometry of the map, such as one or more 3D feature positions 472. The map information 480 can include one or more keyframes 470 corresponding to certain features and certain 3D feature positions 472.

The SLAM system 400 also includes a relocalization engine 455. The relocalization engine 455 can perform relocalization, for instance when the VIO tracker 415 fail to recognize more than a threshold number of features in an image, and/or the VIO tracker 415 loses track of the pose 485 of the SLAM system 400 within the map generated by the mapping engine 430. The relocalization engine 455 can perform relocalization by performing extraction and matching using an extraction and matching engine 460. For instance, the extraction and matching engine 460 can extract features from an image captured by the cameras 410 of the SLAM system 400 while the SLAM system 400 is at a current pose 485, and can match the extracted features to features depicted in different keyframes 470, identified by 3D feature positions 472, and/or identified in the map information 480. By matching these extracted features to the previously-identified features, the relocalization engine 455 can identify that the pose 485 of the SLAM system 400 is a pose 485 at which the previously-identified features are visible to the cameras 410 of the SLAM system 400, and is therefore similar to one or more previous poses 485 at which the previously-identified features were visible to the cameras 410. In some cases, the relocalization engine 455 can perform relocalization based on wide baseline mapping, or a distance between a current camera position and camera position at which feature was originally captured. The relocalization engine 455 can receive information for the pose 485 from the VIO tracker 415, for instance regarding one or more recent poses of the SLAM system 400 and/or cameras 410, which the relocalization engine 455 can base its relocalization determination on. Once the relocalization engine 455 relocates the SLAM system 400 and/or cameras 410 and thus determines the pose 485, the relocalization engine 455 can output the pose 485 to the VIO tracker 415.

In some examples, the VIO tracker 415 can modify the image in the sensor data 465 before performing feature detection, extraction, and/or tracking on the modified image. For example, the VIO tracker 415 can rescale and/or resample the image. In some examples, rescaling and/or resampling the image can include downscaling, downsampling, subscaling, and/or subsampling the image one or more times. In some examples, the VIO tracker 415 modifying the image can include converting the image from color to greyscale, or from color to black and white, for instance by desaturating color in the image, stripping out certain color channel(s), decreasing color depth in the image, replacing colors in the image, or a combination thereof. In some examples, the VIO tracker 415 modifying the image can include the VIO tracker 415 masking certain regions of the image. Dynamic objects can include objects that can have a changed appearance between one image and another. For example, dynamic objects can be objects that move within the environment, such as people, vehicles, or animals. A dynamic object can be an object that has a changing appearance at different times, such as a display screen that may display different things at different times. A dynamic object can be an object that has a changing appearance based on the pose of the camera(s) 410, such as a reflective surface, a prism, or a specular surface that reflects, refracts, and/or scatters light in different ways depending on the position of the camera(s) 410 relative to the dynamic object. The VIO tracker 415 can detect the dynamic objects using facial detection, facial recognition, facial tracking, object detection, object recognition, object tracking, or a combination thereof. The VIO tracker 415 can detect the dynamic objects using one or more artificial intelligence algorithms, one or more trained machine learning models, one or more trained neural networks, or a combination thereof. The VIO tracker 415 can mask one or more dynamic objects in the image by overlaying a mask over an area of the image that includes depiction(s) of the one or more dynamic objects. The mask can be an opaque color, such as black. The area can be a bounding box having a rectangular or other polygonal shape. The area can be determined on a pixel-by-pixel basis.

Returning to FIG. 3, as noted above, XR system 300, including the compute components 310, the XR engine 320, image processing engine 324, the rendering engine 326, the rendering engine 326, the communications engine 328, and/or any combination thereof, can position and/or anchor virtual content in a specific location(s) on the 3D map of the environment (e.g., a 3D map generated by XR system 300 of FIG. 3 and/or SLAM system 400 of FIG. 4), and render the virtual content on the display 309 such that the virtual content appears to be at a location in the environment corresponding to the specific location on the map of the scene where the virtual content is positioned and/or anchored.

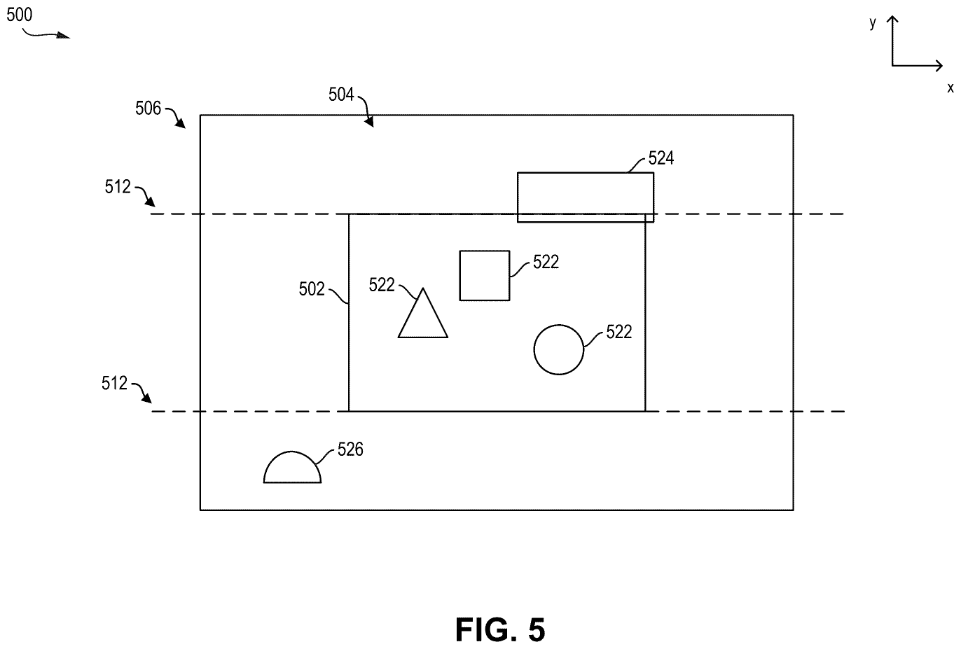

FIG. 5 is a diagram illustrating an example foveated image sensor 500. In some cases, the foveated image sensor 500 of FIG. 5 can be an example of image sensor 130 of FIG. 1, one or more image sensors 302 of FIG. 3, and/or one or more cameras 410 of FIG. 4. In the illustrated example of FIG. 5, the foveated image sensor 500 includes a fovea region 502 (e.g., a subset of pixels of the foveated image sensor 500 that is concentric with a full region 506 of the image sensor (e.g., a full set of pixels of the foveated image sensor 500). In some examples, a peripheral region 504 includes pixels from the full set of pixels of the foveated image sensor 500 that fall outside of the fovea region 502. As shown in FIG. 5, the fovea region 502 may include objects 522. In some cases, the objects 522 may represent a salient portion of the overall scene. In some cases, the fovea region 502 may also include a portion of an object (e.g., object 524) where an additional portion of the object is included in the peripheral region 504 of the foveated image sensor 500. In some cases, an object 526 may be captured only by pixels in the peripheral region 504 of the foveated image sensor 500.

In the illustrated example of FIG. 5, the fovea region 502 is shown as a concentric rectangle relative to the full region 506 that includes one quarter (e.g., 25%) of the pixels of the full region 506. In some implementations, pixels within the fovea region 502 can be read out from the foveated image sensor 500 at full resolution. However, in some cases, the foveated image sensor 500 may be restricted to reading out a full row (e.g., along the x-axis direction) of pixels at a time (e.g., in a roller shutter configuration). In some aspects, such a restriction may result in all of the pixels between the upper and lower boundaries 512 of the fovea region 502 may also be read out at a full resolution. For example, where the height (e.g., number of rows of pixels in the y-axis direction) of the fovea region 502 is half of the height of the full region 506, half (e.g., 50%) of the pixels of the full region 506 will be read out at the full resolution. In some implementations, only the pixels of the foveated image sensor 500 outside of the upper and lower boundaries 512 of the fovea region 502 (e.g., a subset of the peripheral region 504) may be read out at a lower resolution than the pixels between the upper and lower boundaries 512. In one illustrative example, the resolution of the pixels outside of the upper and lower boundaries 512 may be reduced by analog binning (e.g., summation of charge in a 2×2 sub-array of adjacent pixels). In some cases, the amount of data requiring digital readout can be reduced by a factor of four (e.g., corresponding to the binning ratio). In some cases, reducing the amount of data requiring digital readout can reduce power consumption, computational burden for processing pixels (e.g., by the ISP 154 of FIG. 1), memory use (e.g., in an image buffer), among other potential benefits.

As noted above, many devices may not include foveated image sensors such as the foveated image sensor 500 of FIG. 5. In addition, some foveated image sensors may be limited to fixed fovea region(s) (e.g., fovea region 502 of FIG. 5) and fixed peripheral region(s) (e.g., peripheral region 504 of FIG. 5). In some examples, a particular scene may include multiple salient regions that cannot be captured simultaneously by the fixed fovea region(s) simultaneously. In such an example, one or more salient regions may be captured with a lower resolution, FPS, or the like as a result of the fixed fovea region(s).

FIG. 6 is a block diagram illustrating an architecture of an image capture and processing system 600 with an optical arrangement for replicating a foveated sensor. In some cases, the processing system 600 of FIG. 6 may provide benefits of a foveated image sensor (e.g., foveated image sensor 500 of FIG. 5) while avoiding some drawbacks of a foveated image sensor (e.g., fixed fovea region(s)).

The image capture and processing system 600 includes various components that are used to capture and process images of scenes (e.g., an image of a scene 610). The image capture and processing system 600 can capture standalone images (or photographs) and/or can capture videos that include multiple images (or video frames) in a particular sequence. As illustrated in FIG. 6, a beam splitter 690 (e.g., a prism, a mirror, and/or any other beam splitter) can direct a first portion of the incoming light from the scene 610 along a first optical axis toward a first lens 615 and a first image sensor and can direct a second portion of the income light from the scene 610 along a second optical axis toward a second lens 616 and a second image sensor 680.

In some cases, the first lens 615 and first image sensor 630 can be associated with the first optical axis. In one illustrative example, the photosensitive area of the first image sensor 630 (e.g., the photodiodes) and the first lens 615 can both be centered on the first optical axis. In some implementations, the first lens 615 of the image capture and processing system 600 faces a scene 610 and receives light from the scene 610 directed along the first optical axis by the beam splitter 690. The first lens 615 bends incoming light from the scene 610 toward the first image sensor 630. The light received by the first lens 615 passes through an aperture. In some cases, the aperture (e.g., the aperture size) is controlled by one or more control mechanisms 620 and is received by the first image sensor 630. In some cases, the aperture can have a fixed size.

The one or more control mechanisms 620 may control exposure, focus, and/or zoom based on information from the first image sensor 630 and/or based on information from the image processor 650. The one or more control mechanisms 620 may include multiple mechanisms and components; for instance, the control mechanisms 620 may include one or more exposure control mechanisms 625A, one or more focus control mechanisms 625B, and/or one or more zoom control mechanisms 625C. The one or more control mechanisms 620 may also include additional control mechanisms besides those that are illustrated, such as control mechanisms controlling analog gain, flash, HDR, depth of field, and/or other image capture properties for the first image sensor 630.

The focus control mechanism 625B of the control mechanisms 620 can obtain a focus setting. In some examples, focus control mechanism 625B store the focus setting in a memory register. Based on the focus setting, the focus control mechanism 625B can adjust the position of the first lens 615 relative to the position of the first image sensor 630. For example, based on the focus setting, the focus control mechanism 625B can move the first lens 615 closer to the first image sensor 630 or farther from the first image sensor 630 by actuating a motor or servo (or other lens mechanism), thereby adjusting focus. In some cases, additional lenses may be included in the image capture and processing system 600, such as one or more microlenses over each photodiode of the first image sensor 630, which each bend the light received from the first lens 615 toward the corresponding photodiode before the light reaches the photodiode. The focus setting may be determined via CDAF, PDAF, HAF, or some combination thereof. The focus setting may be determined using the control mechanism 620, the first image sensor 630, and/or the image processor 650. The focus setting may be referred to as an image capture setting and/or an image processing setting. In some cases, the first lens 615 can be fixed relative to the image sensor and focus control mechanism 625B can be omitted without departing from the scope of the present disclosure.

The exposure control mechanism 625A of the control mechanisms 620 can obtain an exposure setting. In some cases, the exposure control mechanism 625A stores the exposure setting in a memory register. Based on this exposure setting, the exposure control mechanism 625A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the first image sensor 630 (e.g., ISO speed or film speed), analog gain applied by the first image sensor 630, or any combination thereof. The exposure setting may be referred to as an image capture setting and/or an image processing setting.

The zoom control mechanism 625C of the control mechanisms 620 can obtain a zoom setting. In some examples, the zoom control mechanism 625C stores the zoom setting in a memory register. Based on the zoom setting, the zoom control mechanism 625C can control a focal length of an assembly of lens elements (lens assembly) that includes the first lens 615 and one or more additional lenses. For example, the zoom control mechanism 625C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be first lens 615 in some cases) that receives the light from the scene 610 first, with the light then passing through an afocal zoom system between the focusing lens (e.g., first lens 615) and the first image sensor 630 before the light reaches the first image sensor 630. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 625C moves one or more of the lenses in the afocal zoom system, such as the negative lens and one or both of the positive lenses. In some cases, zoom control mechanism 625C can control the zoom by capturing an image from an image sensor of a plurality of image sensors (e.g., first image sensor 630) with a zoom corresponding to the zoom setting. For example, image capture and processing system 600 can include a wide angle image sensor with a relatively low zoom and a telephoto image sensor with a greater zoom. In some cases, based on the selected zoom setting for a particular image sensor, the zoom control mechanism 625C and/or the zoom control mechanism 675C can capture images from a corresponding image sensor (e.g., first image sensor 630, second image sensor 680).

The first image sensor 630 includes one or more arrays of photodiodes or other photosensitive elements. Each photodiode measures an amount of light that eventually corresponds to a particular pixel in the image produced by the first image sensor 630. In some cases, different photodiodes may be covered by different filters. In some cases, different photodiodes can be covered in color filters, and may thus measure light matching the color of the filter covering the photodiode.

In some cases, the second lens 616 and second image sensor 680 can be associated with the second optical axis from the beam splitter 690. In one illustrative example, the photosensitive area of the second image sensor 680 (e.g., the photodiodes) and the second lens 616 can both be centered on the second optical axis. The second lens 616 of the image capture and processing system 600 receives light from the scene 610 along the second optical axis from the beam splitter 690. The second lens 616 bends incoming light from the scene toward the second image sensor 680. The light received by the second lens 616 passes through an aperture. In some cases, the aperture (e.g., the aperture size) is controlled by one or more control mechanisms 670 and is received by the second image sensor 680. In some cases, the aperture can have a fixed size.

The one or more control mechanisms 670 may control exposure, focus, and/or zoom based on information from the second image sensor 680 and/or based on information from the image processor 650. The one or more control mechanisms 670 may include multiple mechanisms and components; for instance, the control mechanisms 670 may include one or more exposure control mechanisms 675A, one or more focus control mechanisms 675B, and/or one or more zoom control mechanisms 675C. The one or more control mechanisms 670 may also include additional control mechanisms besides those that are illustrated, such as control mechanisms controlling analog gain, flash, HDR, depth of field, and/or other image capture properties.

The focus control mechanism 675B of the control mechanisms 670 can obtain a focus setting. In some examples, focus control mechanism 675B store the focus setting in a memory register. Based on the focus setting, the focus control mechanism 675B can adjust the position of the first lens 615 relative to the position of the second image sensor 680. For example, based on the focus setting, the focus control mechanism 675B can move the second lens 616 closer to the second image sensor 680 or farther from the second image sensor 680 by actuating a motor or servo (or other lens mechanism), thereby adjusting focus. In some cases, additional lenses may be included in the image capture and processing system 600, such as one or more microlenses over each photodiode of the second image sensor 680, which each bend the light received from the second lens 616 toward the corresponding photodiode before the light reaches the photodiode. The focus setting may be determined via CDAF, PDAF, HAF, or some combination thereof. The focus setting may be determined using the control mechanism 670, the second image sensor 680, and/or the image processor 650. The focus setting may be referred to as an image capture setting and/or an image processing setting. In some cases, the second lens 616 can be fixed relative to the image sensor and focus control mechanism 675B can be omitted without departing from the scope of the present disclosure.

The exposure control mechanism 675A of the control mechanisms 670 can obtain an exposure setting. In some cases, the exposure control mechanism 675A stores the exposure setting in a memory register. Based on this exposure setting, the exposure control mechanism 675A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the second image sensor 680 (e.g., ISO speed or film speed), analog gain applied by the second image sensor 680, or any combination thereof. The exposure setting may be referred to as an image capture setting and/or an image processing setting.

The zoom control mechanism 675C of the control mechanisms 670 can obtain a zoom setting. In some examples, the zoom control mechanism 675C stores the zoom setting in a memory register. Based on the zoom setting, the zoom control mechanism 675C can control a focal length of an assembly of lens elements (lens assembly) that includes the second lens 616 and one or more additional lenses. For example, the zoom control mechanism 675C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be second lens 616 in some cases) that receives the light from the scene 610 first, with the light then passing through an afocal zoom system between the focusing lens (e.g., second lens 616) and the second image sensor 680 before the light reaches the second image sensor 680. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 675C moves one or more of the lenses in the afocal zoom system, such as the negative lens and one or both of the positive lenses. In some cases, zoom control mechanism 675C can control the zoom by capturing an image from an image sensor of a plurality of image sensors (e.g., second image sensor 680) with a zoom corresponding to the zoom setting. In some cases, based on the selected zoom setting, the zoom control mechanism 675C can capture images from a corresponding sensor.

The second image sensor 680 includes one or more arrays of photodiodes or other photosensitive elements. Each photodiode measures an amount of light that eventually corresponds to a particular pixel in the image produced by the second image sensor 680. In some cases, different photodiodes may be covered by different filters. In some cases, different photodiodes can be covered in color filters, and may thus measure light matching the color of the filter covering the photodiode.

As noted above, a color filter array can cover the one or more arrays of photodiodes (or other photosensitive elements) of the first image sensor 630 and/or the second image sensor 680. The color filter array can include a quad color filter array in some implementations, such as the quad color filter array 200 shown in FIG. 2A. In certain situations, after an image is captured by the first image sensor 630 (e.g., before the image is provided to and processed by the first ISP 654), the first image sensor 630 can perform a binning process to bin the quad color filter array 200 pattern into a binned Bayer pattern. Additionally and/or alternatively, after an image is captured by the second image sensor 680 (e.g., before the image is provided to and processed by the second ISP 655), the second image sensor 680 can perform a binning process to bin the quad color filter array 200 pattern into a binned Bayer pattern.

For instance, as shown in FIG. 2B (described above), the quad color filter array 200 pattern can be converted to a Bayer color filter array pattern (with reduced resolution) by applying the binning process. The binning process can increase SNR, resulting in increased sensitivity and reduced noise in the captured image. In one illustrative example, binning can be performed in low-light settings when lighting conditions are poor, which can result in a high quality image with higher brightness characteristics and less noise.

In some examples, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., first image sensor 630, second image sensor 680) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the first image sensor 630 and/or second image sensor 680 may alternately or additionally include opaque and/or reflective masks that block light from reaching certain photodiodes, or portions of certain photodiodes, at certain times and/or from certain angles. In some cases, opaque and/or reflective masks may be used for PDAF. In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The second image sensor 680 may also include an analog gain amplifier to amplify the analog signals output by the photodiodes and/or an ADC to convert the analog signals output of the photodiodes (and/or amplified by the analog gain amplifier) into digital signals. In some cases, certain components or functions discussed with respect to one or more of the control mechanisms 670 may be included instead or additionally in the second image sensor 680. The second image sensor 680 may be a CCD sensor, an EMCCD sensor, an APS, a CMOS sensor, an NMOS sensor, a hybrid CCD/CMOS sensor (e.g., sCMOS), or some other combination thereof.

In some implementations, the first image sensor 630 can be utilized as a full region image sensor and the second image sensor 680 can be utilized as a fovea region image sensor. In some cases, a first optical system (e.g., including first lens 615) for the first image sensor may capture images of the scene 610 with a first spatial resolution. In one illustrative example, the first optical system can be implemented as a telephoto lens system. In some cases, the first spatial resolution can correspond to a magnification of the first optical system. In some examples, the zoom control mechanism 625C can be utilized to control a zoom of the first optical system.

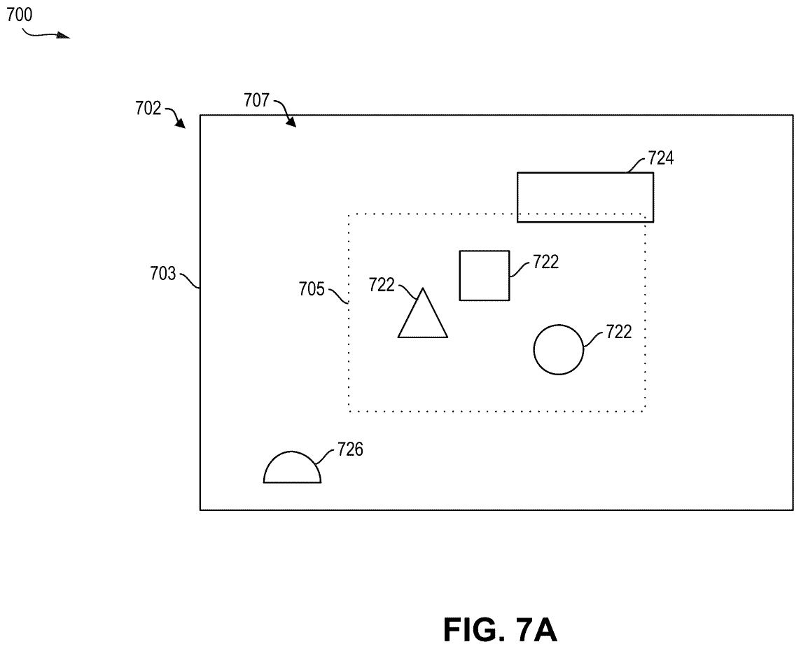

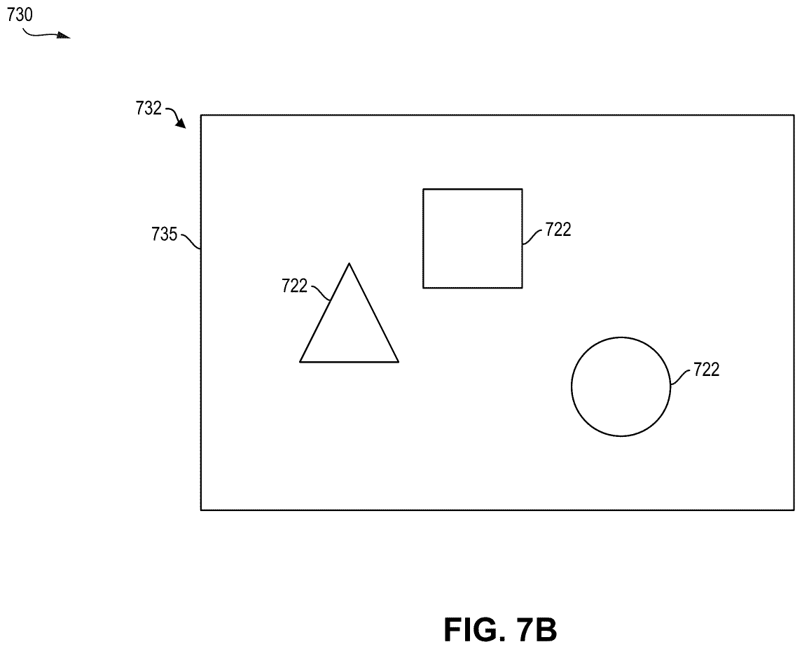

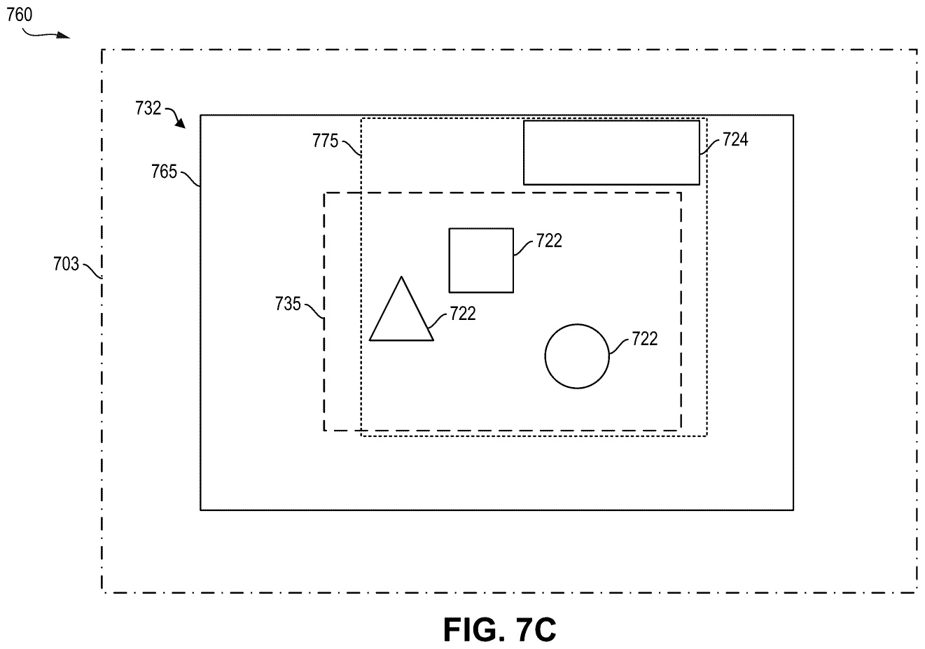

FIG. 7A is a diagram 700 illustrating an example full region image sensor 702. In some cases, the full region image sensor 702 can correspond to the first image sensor 630 of FIG. 6. For the purposes of illustration, the full region 703 of the full region image sensor 702 of FIG. 7A is illustrated with a scene including objects 722, 724, 726 that correspond to the objects 522, 524, 526, respectively, of FIG. 5. In the illustrated example of FIG. 7A, a fovea region 705 illustrated by a dotted outline includes the objects 722 and a portion of the object 726 and is similar to the fovea region 502 of FIG. 5 including the objects 522 and a portion of the object 524 of FIG. 5. However, unlike the foveated image sensor 500 of FIG. 5, the full region image sensor 702 of FIG. 7A is configured to read out all of the pixels in the full region 703 at a uniform resolution and data rate. As illustrated in FIG. 7A, a peripheral region 707 includes a portion of the full region 703 outside of the fovea region 705. In some implementations, a pixel density of the full region image sensor 702 may be similar to an effective pixel density of the pixels outside of the upper and lower boundaries 512 of the fovea region 502 of the foveated image sensor 500 of FIG. 5.

Returning to FIG. 6, in some implementations, a second optical system (e.g., including second lens 616) for the second image sensor 680 may capture images of the scene 610 with a second spatial resolution. In some examples, the second spatial resolution can correspond to a magnification provided by the second optical system. In some aspects, the first spatial resolution provided by the first optical system can be different from the second spatial resolution provided by the second optical system. For example, in some cases, the second magnification can be greater than the first magnification such that the second image sensor 680 captures a portion of the scene corresponding to fovea region 502 of FIG. 5 relative to the full region captured by the first image sensor 630.

FIG. 7B is a diagram 730 illustrating an example fovea region image sensor 732. In the illustrated example of FIG. 7B, the fovea region image sensor 732 can capture a fovea region 735 of the scene captured by the full region image sensor 702 of FIG. 7A. In the illustrated example of FIG. 7B, the fovea region 735 includes only the objects 722 while excluding the portion of the object 724. For example, the second optical system (e.g., including second lens 616) of FIG. 6 may be configured with a zoom that captures the objects 722 that excludes the portion of the object 724. In some cases, by providing the fovea region image sensor 732 with an optical system that has a zoom control independent of zoom control for the full region image sensor 702 of FIG. 7A, the fovea region can have a variable size relative to the full region captures by the full region image sensor 702. In contrast, a foveated image sensor (e.g., foveated image sensor 500 of FIG. 5) may be limited to a fixed size relationship between the fovea region (e.g., fovea region 502 of FIG. 5) and the full region (e.g., full region 506 of FIG. 5, full region 703 of FIG. 7A).

FIG. 7C is a diagram 760 illustrating the example fovea region image sensor 732 operating with an adjusted fovea region 765. For the purposes of illustration, the fovea region 735 of FIG. 7B is shown with a dashed outline within the adjusted fovea region 765 of FIG. 7C. In the illustrated example of FIG. 7C, the adjusted fovea region 765 has been expanded relative to the fovea region 735 of FIG. 7B such that the object 724 is fully included within the adjusted fovea region 765. In one illustrative example, an image processor (e.g., image processor 650 of FIG. 6) may be configured to perform object classification on images captured by at least one of the full region image sensor (e.g., full region image sensor 702 of FIG. 7A) or the fovea image sensor (e.g., fovea region image sensor 732 of FIG. 7B and FIG. 7C). For example, the rectangular object 724 may represent a vehicle, and the image processor may be configured in a vehicle detection mode. In some implementations, once the image processor detects a vehicle (e.g., the object 724), the image processor may output an adjusted fovea region for the fovea region image sensor 732 that includes the object 724. In one illustrative example, a machine learning model (e.g., a deep learning neural network) may be utilized to perform object classification on the images captured by at least one of the full region image sensor (e.g., full region image sensor 702 of FIG. 7A) or the fovea image sensor (e.g., fovea region image sensor 732 of FIG. 7B and FIG. 7C).

In another illustrative example, an image processor (e.g., image processor 650 of FIG. 6), may be configured to detect motion in images obtained by at least one of the full region image sensor (e.g., full region image sensor 702 of FIG. 7A) or the fovea image sensor (e.g., fovea region image sensor 732 of FIG. 7B and FIG. 7C). In some cases, if the image processor determines that local motion is present in a portion of the scene outside that is not captured in the fovea region, the image processor may output an adjusted fovea region for the fovea region image sensor 732 that includes the object 724.

In one illustrative example, a salient region 775 (illustrated by a short-dashed rectangle) may be off-center relative to the fovea region 735. In some cases, an optical system (e.g., the second optical system of FIG. 6) for the fovea region image sensor 732 may adjust the spatial resolution for the fovea region image sensor 732. For example, the optical system for the fovea region image sensor 732 may decrease magnification until the entire salient region 775 is contained within the adjusted fovea region 765.

While FIG. 7C illustrates an adjusted fovea region 765 that can be obtained by adjusting a spatial resolution (e.g., by reducing a magnification of the second optical system of FIG. 6)) for the fovea region image sensor (e.g., fovea region image sensor 732 of FIG. 7B and FIG. 7C), other techniques for adjusting the fovea region may be used without departing from the scope of the present disclosure. For example, in some cases, an image capture and processing system (e.g., image capture and processing system 600 of FIG. 6) may include two or more fovea image sensors that can be used to capture different fovea regions. In one illustrative example, the adjusted fovea region 765 may be captured by at least one of the two or more fovea image sensors. In some cases, images from each fovea image sensor may be processed by a different ISP. In some implementations, images from two or more fovea image sensors may be processed by a common ISP. In some cases, fovea regions associated with two or more fovea image sensors may be concentric.

In some cases, fovea regions associated with two or more fovea image sensors may not be concentric (e.g., offset fovea region image sensors without a beam splitter). In one illustrative example, different fovea image sensors selected from the two or more fovea image sensors may be used to capture images of the fovea region 735, adjusted fovea region 765, and/or salient region 775. For example, an image capture and processing system may select a fovea image sensor from the two or more fovea image sensors that provides the highest spatial resolution for the region being captured. In some cases, an image capture and processing system may determine that the salient region 775 is centered relative to at least one fovea image sensor of the two or more fovea image sensors. In such an example, the at least one fovea image sensor of the two or more fovea image sensors that is centered relative to the salient region 775 may capture an image with a spatial resolution that corresponds to the salient region 775. In some cases, selecting the at least one fovea image sensor of the two or more image sensors that is centered relative to the salient region 775 may provide an increased spatial resolution capture of the salient region 775 relative to capturing an image of an adjusted fovea region (e.g., adjusted fovea region 765) that extends beyond the salient region 775.

In some cases, a post-processing engine (e.g., post-processing engine 658 of FIG. 6) of an image processor (e.g., image processor 650 of FIG. 6) can combine the full region image and multiple fovea image (e.g., from the two or more fovea region image sensors) into a combined image. In some aspects, at least one of the fovea images captured by the two or more fovea region image sensors may be warped to align the images.

Returning to FIG. 6, the image processor 650 may include one or more processors, such as one or more ISPs (including first ISP 654, second ISP 655), one or more host processors (including host processor 652), and/or one or more of any other type of processor 1310 discussed with respect to the computing system 1300 of FIG. 13. In some implementations, the first ISP 654 can perform image processing functionality for images captured by the first image sensor 630. In some cases, the second ISP 655 can perform image processing functionality for images captured by the second image sensor 680. In some aspects, by providing a first ISP 654 and second ISP 655 for the first image sensor 630 and the second image sensor 680, respectively, images can be processed in parallel from both image sensors to meet timing requirements of the processing system 600. In some cases, a processing system 600 may be implemented with a single ISP (not shown) that can process images from both the first image sensor 630 and the second image sensor 680.

In some examples, the host processor 652 can be a digital signal processor (DSP) and/or other type of processor. In some implementations, the image processor 650 is a single integrated circuit or chip (e.g., referred to as a system-on-chip or SoC) that includes the host processor 652 and the first ISP 654. In some cases, the chip can also include one or more I/O ports (e.g., I/O ports 656), CPUs, GPUs, broadband modems (e.g., 3G, 4G or LTE, 5G, etc.), memory, connectivity components (e.g., Bluetooth™, GPS, etc.), any combination thereof, and/or other components. The I/O ports 656 can include any suitable input/output ports or interface according to one or more protocol or specification, such as an I2C interface, an I3C interface, an SPI interface, a serial General Purpose Input/Output (GPIO) interface, a MIPI (such as a MIPI CSI-2 PHY layer port or interface, an AHB bus, any combination thereof, and/or other input/output port. In one illustrative example, the host processor 652 can communicate with the first image sensor 630 and/or the second image sensor 680 using an I2C port, and the first ISP 654 can communicate with the first image sensor 630 and/or the second image sensor 680 using an MIPI port.

The image processor 650 may perform a number of tasks, such as de-mosaicing, color space conversion, image frame downsampling, pixel interpolation, AE control, AGC, CDAF, PDAF, automatic white balance, merging of image frames to form an HDR image, image recognition, object recognition, feature recognition, receipt of inputs, managing outputs, managing memory, or some combination thereof. The image processor 650 may store image frames and/or processed images in RAM 640/1325, ROM 645/1320, a cache, a memory unit, another storage device, or some combination thereof.

In some implementations, the post-processing engine 658 of the image processor 650 can generate combined images based on the images (e.g., full region images) obtained from the first image sensor 630 (e.g., after processing by the first ISP 654) and images (e.g., fovea region images) obtained from the second image sensor 680 (e.g., after processing by the second ISP 655). In some implementations, the post-processing engine 658 may blend and/or fuse pixels from the full region images and the fovea region images to generate a combined image. In some cases, the post-processing engine 658 may combine full images from the second image sensor 680 (e.g., fovea region images) with an upscaled representation of a peripheral region from images from the first image sensor 630 (e.g., full region images).

Various I/O devices 660 may be connected to the image processor 650. The I/O devices 660 can include a display screen, a keyboard, a keypad, a touchscreen, a trackpad, a touch-sensitive surface, a printer, any other output devices 1335, any other input devices 1345, or some combination thereof. In some cases, a caption may be input into the image processing device 605B through a physical keyboard or keypad of the I/O devices 660, or through a virtual keyboard or keypad of a touchscreen of the I/O devices 660. The I/O 660 may include one or more ports, jacks, or other connectors that enable a wired connection between the image capture and processing system 600 and one or more peripheral devices, over which the image capture and processing system 600 may receive data from the one or more peripheral device and/or transmit data to the one or more peripheral devices. The I/O 660 may include one or more wireless transceivers that enable a wireless connection between the image capture and processing system 600 and one or more peripheral devices, over which the image capture and processing system 600 may receive data from the one or more peripheral device and/or transmit data to the one or more peripheral devices. The peripheral devices may include any of the previously discussed types of I/O devices 660 and may themselves be considered I/O devices 660 once they are coupled to the ports, jacks, wireless transceivers, or other wired and/or wireless connectors.

In some cases, the image capture and processing system 600 may be a single device. In some cases, the image capture and processing system 600 may be two or more separate devices, including an image capture device 605A (e.g., a camera) and an image processing device 605B (e.g., a computing device coupled to the camera). In some implementations, the image capture device 605A and the image processing device 605B may be coupled together, for example via one or more wires, cables, or other electrical connectors, and/or wirelessly via one or more wireless transceivers. In some implementations, the image capture device 605A and the image processing device 605B may be disconnected from one another vertical dashed line divides the image capture and processing system 600 of FIG. 6 into two portions that represent the image capture device 605A and the image processing device 605B, respectively. The image capture device 605A includes the first lens 615, the second lens 616, control mechanisms 670, control mechanisms 670, the first image sensor 630, and the second image sensor 680. The image processing device 605B includes the image processor 650 (including the first ISP 654, second ISP 655 and the host processor 652), the RAM 640, the ROM 645, and the I/O 660. In some cases, certain components illustrated in the image processing device 605B, such as the first ISP 654, second ISP 655, and/or the host processor 652, may be included in the image capture device 605A.

The image capture and processing system 600 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an IP camera, or any other suitable electronic device. In some examples, the image capture and processing system 600 can include one or more wireless transceivers for wireless communications, such as cellular network communications, 802.11 wi-fi communications, WLAN communications, or some combination thereof. In some implementations, the image capture device 605A and the image processing device 605B can be different devices. For instance, the image capture device 605A can include a camera device and the image processing device 605B can include a computing device, such as a mobile handset, a desktop computer, or other computing device.

While the image capture and processing system 600 is shown to include certain components, one of ordinary skill will appreciate that the image capture and processing system 600 can include more or fewer components than those shown in FIG. 6. In some cases, the image capture and processing system 600 can include software, hardware, or one or more combinations of software and hardware. For example, in some implementations, the components of the image capture and processing system 600 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 600.

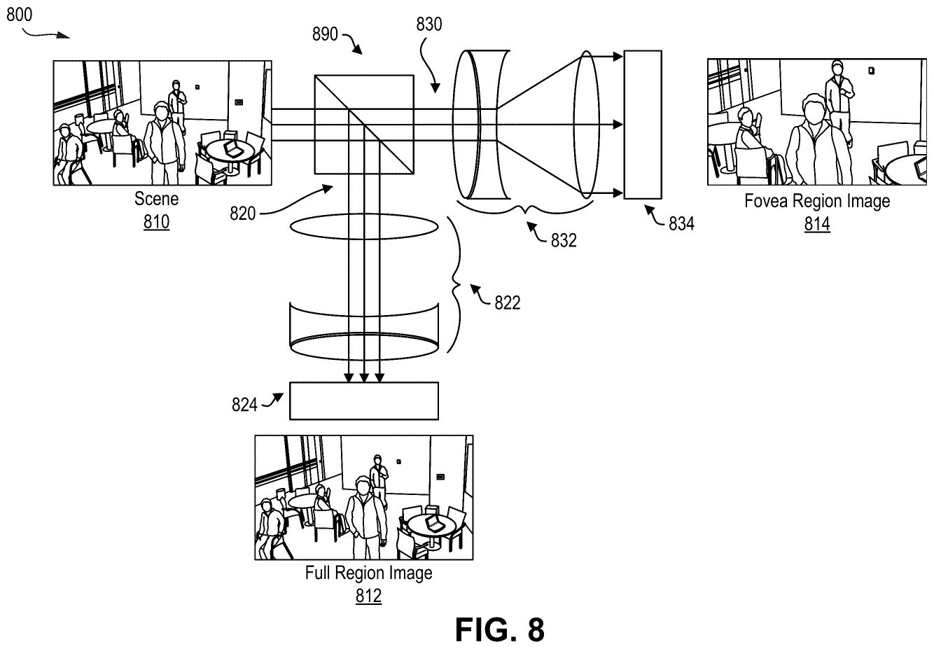

FIG. 8 illustrates an example of an optical arrangement for foveated sensing 800. In the illustrated example of FIG. 8, a beam splitter 890 is configured to split light from a scene 810 between a full region image sensor 824 and a fovea region image sensor 834. In some aspects, the beam splitter 890 can be similar to and/or may perform similar functions to the beam splitter 690 of FIG. 6. In some cases, the full region image sensor 824 may be similar to and/or perform similar functions to the first image sensor 630 of FIG. 6. In some implementations, the full region image sensor 824 may correspond to the full region image sensor 702 of FIG. 7A. In some examples, the fovea region image sensor 834 may be similar and/or perform similar functions to second image sensor 680 of FIG. 6. In some aspects, the fovea region image sensor 834 may correspond to the fovea region image sensor 732 of FIG. 7B and FIG. 7C.

As illustrated in FIG. 8, the full region image sensor 824 and a first optical system 822 may be associated with a first optical axis 820. In some aspects, the full region image sensor 824 and the first optical system 822 may be aligned relative to the first optical axis 820. In some cases, a spatial resolution (e.g., magnification, zoom, or the like) for an image captured by the full region image sensor 824 may be adjusted (e.g., by adjusting a zoom of the first optical system 822) such that the full region image sensor 824 captures a full region image 812.

In some implementations, the fovea region image sensor 834 and a second optical system 832 may be associated with a second optical axis 830. In some examples, the fovea region image sensor 834 and the second optical system 832 may be aligned relative to the second optical axis 830. In some aspects, a spatial resolution (e.g., magnification, zoom, or the like) for an image captured by the fovea region image sensor 834 may be adjusted such that the fovea region image sensor 834 captures a fovea region image 814.

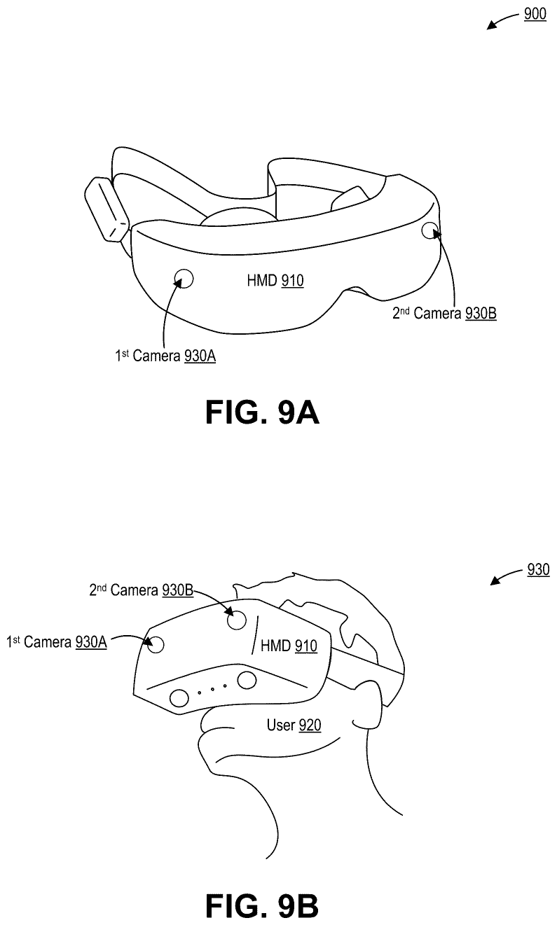

FIG. 9A is a perspective diagram 900 illustrating a head-mounted display (HMD) 910 that performs feature tracking and/or visual simultaneous localization and mapping (VSLAM), in accordance with some examples. The HMD 910 may be, for example, an augmented reality (AR) headset, a virtual reality (VR) headset, a mixed reality (MR) headset, an extended reality (XR) headset, or some combination thereof. The HMD 910 may be an example of an XR system 300, a SLAM system 400, or a combination thereof. The HMD 910 includes a first camera 930A and a second camera 930B along a front portion of the HMD 910. The first camera 930A and the second camera 930B may be two of image sensor 302. In some examples, the HMD 910 may only have a single camera. In some examples, the HMD 910 may include one or more additional cameras in addition to the first camera 930A and the second camera 930B. In some examples, the HMD 910 may include one or more additional sensors in addition to the first camera 930A and the second camera 930B.

FIG. 9B is a perspective diagram 930 illustrating the head-mounted display (HMD) 910 of FIG. 9A being worn by a user 920, in accordance with some examples. The user 920 wears the HMD 910 on the user 920's head over the user 920's eyes. The HMD 910 can capture images with the first camera 930A and the second camera 930B. In some examples, the HMD 910 displays one or more display images toward the user 920's eyes that are based on the images captured by the first camera 930A and the second camera 930B. The display images may provide a stereoscopic view of the environment, in some cases with information overlaid and/or with other modifications. For example, the HMD 910 can display a first display image to the user 920's right eye, the first display image based on an image captured by the first camera 930A. The HMD 910 can display a second display image to the user 920's left eye, the second display image based on an image captured by the second camera 930B. For instance, the HMD 910 may provide overlaid information in the display images overlaid over the images captured by the first camera 930A and the second camera 930B.

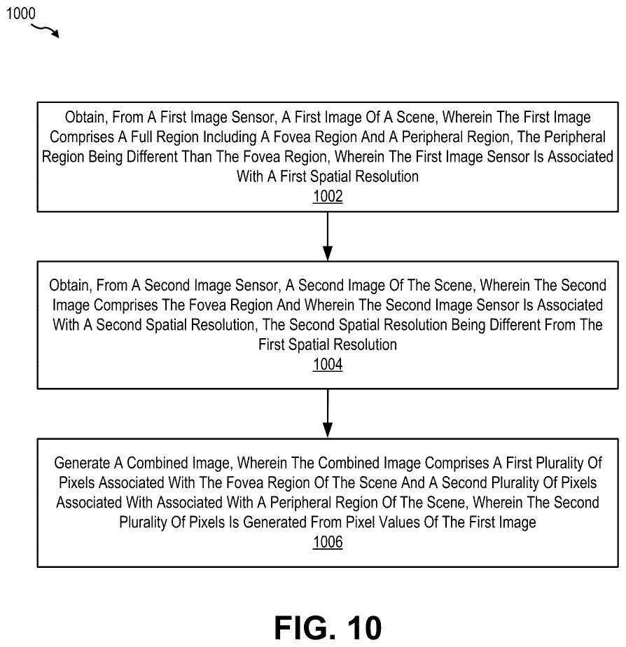

FIG. 10 is a flow diagram of a process 1000 for alignment of displayed virtual content. The process 1000 may be performed by a computing device (or apparatus) or a component (e.g., a chipset, codec, etc.) of the computing device. The computing device may be a mobile device, a network-connected wearable such as a watch, an extended reality (XR) device (e.g., XR system 300 of FIG. 3) such as a VR device or AR device, a vehicle or component or system of a vehicle, a network node/entity/device, wireless device, or other type of computing device. The operations of the process 1000 may be implemented as software components that are executed and run on one or more processors.

At block 1002, the computing device (or component thereof) may obtain, from a first image sensor (e.g., first image sensor 630 of FIG. 6, full region image sensor 824 of FIG. 8), a first image of a scene (e.g., full region image 812 of FIG. 8). In some cases, the first image includes a full region (e.g., full region 703 of FIG. 7A) including a fovea region (e.g., fovea region 705 of FIG. 7A) and a peripheral region (e.g., peripheral region 707 of FIG. 7A), the peripheral region being different than the fovea region. In some examples, the first image sensor is associated with a first spatial resolution (e.g., zoom, magnification, etc.). In some implementations, the first spatial resolution is associated with a first optical system (e.g., first optical system 822 of FIG. 8) and the first optical system and the first image sensor are aligned relative to a first optical axis (e.g., first optical axis 820 of FIG. 8). In some aspects, the full region and the peripheral region are concentric.

At block 1004, the computing device (or component thereof) may obtain, from a second image sensor (e.g., second image sensor 680 of FIG. 6, fovea region image sensor 834 of FIG. 8, a second image of the scene (e.g., fovea region image 814 of FIG. 8). In some cases, the second image includes the fovea region (e.g., fovea region 735 of FIG. 7B). In some examples, the second image sensor is associated with a second spatial resolution, the second spatial resolution being different from the first spatial resolution. In some implementations, the second spatial resolution is associated with a second optical system (e.g., second optical system 832 of FIG. 8) and the second optical system and the second image sensor are aligned relative to a second optical axis (e.g., second optical axis 830 of FIG. 8). In some aspects, the second optical system is different from the first optical system. In some cases, the second optical axis is at least partially different from the first optical axis. In some examples, the second optical system provides a variable spatial resolution.

At block 1006, the computing device (or component thereof) may generate a combined image. In some examples, the combined image includes a first plurality of pixels associated with the fovea region of the scene and a second plurality of pixels associated with associated with a peripheral region of the scene. In some implementations, the second plurality of pixels is generated from pixel values of the first image. In some aspects, generating the combined image includes upscaling the peripheral region from the first image and combining the second image with the upscaled peripheral region from the first image. In some cases, generating the combined image includes blending the fovea region from the second image with the first image.

In some implementations, a first ISP (e.g., first ISP 654 of FIG. 6) is configured to process the first image from the first image sensor; and a second ISP (e.g., second ISP 655 of FIG. 6) is configured to process the second image from the second image sensor. In some cases, the first ISP and the second ISP process the first image and the second image, respectively, in parallel.

In some examples, an ISP is configured to process the first image from the first image sensor and to process the second image from the second image sensor.

In some implementations, the computing device (or component thereof) may determine, based on at least one of the first image or the second image, an adjusted fovea region (e.g., adjusted fovea region 765 of FIG. 7B) and may adjust the second optical system in accordance with the adjusted fovea region. In some cases, adjusting the second optical system in accordance with adjusted the fovea region includes adjusting the second spatial resolution associated with the second optical system. In some examples, determining the adjusted fovea region includes detecting an object based on an image classification and adjusting the fovea region to include the object. In some aspects, determining the adjusted fovea region includes detecting local motion in a portion of the scene based on motion detection and adjusting the fovea region to include the portion of the scene.

In some cases, the adjusted fovea region extends outside of the fovea region and is off-center relative to the second optical axis (e.g., salient region 775 of FIG. 7C); and adjusting the second spatial resolution associated with the second optical system includes decreasing a magnification of the second optical system to include the adjusted fovea region.

In some implementations, the computing device (or component thereof) may determine, based on at least one of the first image or the second image, an adjusted fovea region. In some examples, the adjusted fovea region is off-center relative to the second optical axis. In some cases, the computing device (or component thereof) may obtain, from a third image sensor, based on the adjusted fovea region, a third image of the scene. In some examples, the second image includes the adjusted fovea region. In some aspects, the third image sensor is different from the first image sensor and the second image sensor.

In some implementations, the first image sensor is configured to capture images at a first frame rate and the second image sensor is configured to capture images at a second frame rate, the first frame rate being slower than the second frame rate.

In some examples, generating the combined image includes upscaling the peripheral region from the first image and combining the second image with the upscaled peripheral region from the first image. In some aspects, generating the combined image includes blending the fovea region from the second image with the first image.

The process 1000 can also be performed by a computing device with the architecture of the computing system 1300 shown in FIG. 13. The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein, including the process 1000. In some cases, the computing device or apparatus may include various components, such as one or mor e input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes illustrated by block diagrams in FIG. 1 (of image capture and processing system 100), FIG. 3 (of XR system 300), FIG. 4 (of SLAM system 400), FIG. 6 (of image capture and processing system 600), and FIG. 13 (of computing system 1300) and the flow diagram illustrating process 1000 are illustrative of, or organized as, logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes illustrated by block diagrams 100, 300, 400, 600, and 1300 and the flow diagram illustrating process 1000 and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

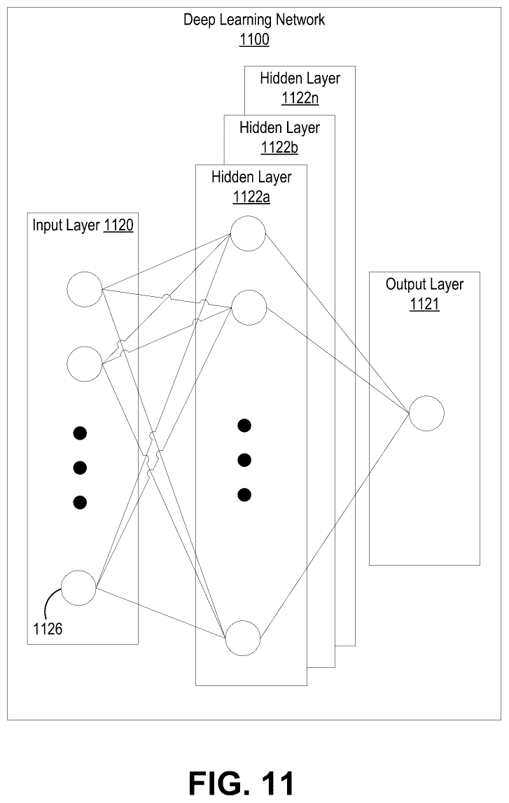

As noted above, various aspects of the present disclosure can use machine learning models or systems. FIG. 11 is an illustrative example of a deep learning neural network 1100 that can be used to implement the machine learning based feature extraction and/or activity recognition (or classification) described above. An input layer 1120 includes input data. In one illustrative example, the input layer 1120 can include data representing the pixels of an input video frame. The neural network 1100 includes multiple hidden layers 1122a, 1122b, through 1122n. The hidden layers 1122a, 1122b, through 1122n include “n” number of hidden layers, where “n” is an integer greater than or equal to one. The number of hidden layers can be made to include as many layers as needed for the given application. The neural network 1100 further includes an output layer 1121 that provides an output resulting from the processing performed by the hidden layers 1122a, 1122b, through 1122n. In one illustrative example, the output layer 1121 can provide a classification for an object in an input video frame. The classification can include a class identifying the type of activity (e.g., looking up, looking down, closing eyes, yawning, etc.).

The neural network 1100 is a multi-layer neural network of interconnected nodes. Each node can represent a piece of information. Information associated with the nodes is shared among the different layers and each layer retains information as information is processed. In some cases, the neural network 1100 can include a feed-forward network, in which case there are no feedback connections where outputs of the network are fed back into itself. In some cases, the neural network 1100 can include a recurrent neural network, which can have loops that allow information to be carried across nodes while reading in input.

Information can be exchanged between nodes through node-to-node interconnections between the various layers. Nodes of the input layer 1120 can activate a set of nodes in the first hidden layer 1122a. For example, as shown, each of the input nodes of the input layer 1120 is connected to each of the nodes of the first hidden layer 1122a. The nodes of the first hidden layer 1122a can transform the information of each input node by applying activation functions to the input node information. The information derived from the transformation can then be passed to and can activate the nodes of the next hidden layer 1122b, which can perform their own designated functions. Example functions include convolutional, up-sampling, data transformation, and/or any other suitable functions. The output of the hidden layer 1122b can then activate nodes of the next hidden layer, and so on. The output of the last hidden layer 1122n can activate one or more nodes of the output layer 1121, at which an output is provided. In some cases, while nodes (e.g., node 1126) in the neural network 1100 are shown as having multiple output lines, a node has a single output and all lines shown as being output from a node represent the same output value.

In some cases, each node or interconnection between nodes can have a weight that is a set of parameters derived from the training of the neural network 1100. Once the neural network 1100 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 1100 to be adaptive to inputs and able to learn as more and more data is processed.

The neural network 1100 is pre-trained to process the features from the data in the input layer 1120 using the different hidden layers 1122a, 1122b, through 1122n in order to provide the output through the output layer 1121. In an example in which the neural network 1100 is used to identify activities being performed by a driver in frames, the neural network 1100 can be trained using training data that includes both frames and labels, as described above. For instance, training frames can be input into the network, with each training frame having a label indicating the features in the frames (for the feature extraction machine learning system) or a label indicating classes of an activity in each frame. In one example using object classification for illustrative purposes, a training frame can include an image of a number 2, in which case the label for the image can be [0 0 1 0 0 0 0 0 0 0].

In some cases, the neural network 1100 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until the neural network 1100 is trained well enough so that the weights of the layers are accurately tuned.

For the example of identifying objects in frames, the forward pass can include passing a training frame through the neural network 1100. The weights are initially randomized before the neural network 1100 is trained. As an illustrative example, a frame can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for the neural network 1100, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 1100 is unable to determine low level features and thus cannot make an accurate determination of what the classification of the object might be. A loss function can be used to analyze error in the output. Any suitable loss function definition can be used, such as a Cross-Entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 1100 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and η denotes a learning rate. The learning rate can be set to any suitable value, with a high learning rate including larger weight updates and a lower value indicating smaller weight updates.

The neural network 1100 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 1100 can include any other deep network other than a CNN, such as an autoencoder, a deep belief nets (DBNs), a Recurrent Neural Networks (RNNs), among others.

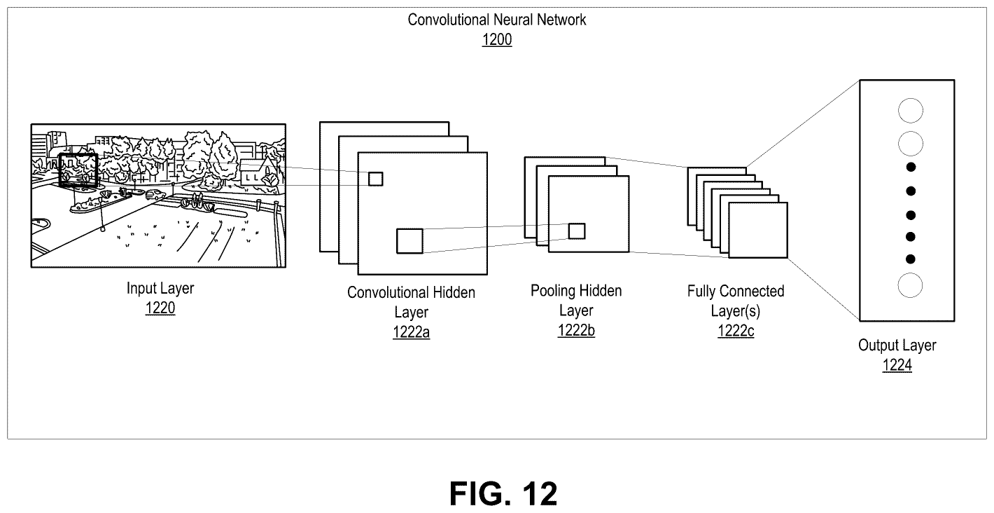

FIG. 12 is an illustrative example of a convolutional neural network (CNN) 1200. The input layer 1220 of the CNN 1200 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1222a, an optional non-linear activation layer, a pooling hidden layer 1222b, and fully connected hidden layers 1222c to get an output at the output layer 1224. While only one of each hidden layer is shown in FIG. 12, one of ordinary skill will appreciate that multiple convolutional hidden layers, non-linear layers, pooling hidden layers, and/or fully connected layers can be included in the CNN 1200. As previously described, the output can indicate a single class of an object or can include a probability of classes that best describe the object in the image.

The first layer of the CNN 1200 is the convolutional hidden layer 1222a. The convolutional hidden layer 1222a analyzes the image data of the input layer 1220. Each node of the convolutional hidden layer 1222a is connected to a region of nodes (pixels) of the input image called a receptive field. The convolutional hidden layer 1222a can be considered as one or more filters (each filter corresponding to a different activation or feature map), with each convolutional iteration of a filter being a node or neuron of the convolutional hidden layer 1222a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1222a. Each connection between a node and a receptive field for that node learns a weight and, in some cases, an overall bias such that each node learns to analyze its particular local receptive field in the input image. Each node of the hidden layer 1222a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 1222a is due to each node of the convolutional layer being applied to its corresponding receptive field. For example, a filter of the convolutional hidden layer 1222a can begin in the top-left corner of the input image array and can convolve around the input image. As noted above, each convolutional iteration of the filter can be considered a node or neuron of the convolutional hidden layer 1222a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1222a. For example, a filter can be moved by a step amount (referred to as a stride) to the next receptive field. The stride can be set to 1 or another suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1222a.

The mapping from the input layer to the convolutional hidden layer 1222a is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1222a can include several activation maps in order to identify multiple features in an image. The example shown in FIG. 12 includes three activation maps. Using three activation maps, the convolutional hidden layer 1222a can detect three different kinds of features, with each feature being detectable across the entire image.

In some examples, a non-linear hidden layer can be applied after the convolutional hidden layer 1222a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1200 without affecting the receptive fields of the convolutional hidden layer 1222a.

The pooling hidden layer 1222b can be applied after the convolutional hidden layer 1222a (and after the non-linear hidden layer when used). The pooling hidden layer 1222b is used to simplify the information in the output from the convolutional hidden layer 1222a. For example, the pooling hidden layer 1222b can take each activation map output from the convolutional hidden layer 1222a and generates a condensed activation map (or feature map) using a pooling function. Max-pooling is one example of a function performed by a pooling hidden layer. Other forms of pooling functions be used by the pooling hidden layer 1222a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1222a. In the example shown in FIG. 12, three pooling filters are used for the three activation maps in the convolutional hidden layer 1222a.

In some examples, max-pooling can be used by applying a max-pooling filter (e.g., having a size of 2×2) with a stride (e.g., equal to a dimension of the filter, such as a stride of 2) to an activation map output from the convolutional hidden layer 1222a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1222a having a dimension of 24×24 nodes, the output from the pooling hidden layer 1222b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

Intuitively, the pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1200.

The final layer of connections in the network is a fully-connected layer that connects every node from the pooling hidden layer 1222b to every one of the output nodes in the output layer 1224. Using the example above, the input layer includes 28×28 nodes encoding the pixel intensities of the input image, the convolutional hidden layer 1222a includes 3×24×24 hidden feature nodes based on application of a 5×5 local receptive field (for the filters) to three activation maps, and the pooling hidden layer 1222b includes a layer of 3×12×12 hidden feature nodes based on application of max-pooling filter to 2×2 regions across each of the three feature maps. Extending this example, the output layer 1224 can include ten output nodes. In such an example, every node of the 3×12×12 pooling hidden layer 1222b is connected to every node of the output layer 1224.

The fully connected layer 1222c can obtain the output of the previous pooling hidden layer 1222b (which should represent the activation maps of high-level features) and determines the features that most correlate to a particular class. For example, the fully connected layer 1222c layer can determine the high-level features that most strongly correlate to a particular class and can include weights (nodes) for the high-level features. A product can be computed between the weights of the fully connected layer 1222c and the pooling hidden layer 1222b to obtain probabilities for the different classes. For example, if the CNN 1200 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1224 can include an M-dimensional vector (in the prior example, M=10). M indicates the number of classes that the CNN 1200 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 13 is a diagram illustrating an example of a system for implementing certain aspects of the present technology. In particular, FIG. 13 illustrates an example of computing system 1300, which can be for example any computing device making up the image capture and processing system 100 of FIG. 1, the image capture device 105A of FIG. 1, the image processing device 105B of FIG. 1, the XR system 300 of FIG. 3, the SLAM system 400 of FIG. 4, the image capture and processing system 600 of FIG. 6, the image capture device 605A of FIG. 6, the image processing device 605B of FIG. 6, or any component thereof in which the components of the system are in communication with each other using connection 1305. Connection 1305 can be a physical connection using a bus, or a direct connection into processor 1310, such as in a chipset architecture. Connection 1305 can also be a virtual connection, networked connection, or logical connection.

In some aspects, computing system 1300 is a distributed system in which the functions described in this disclosure can be distributed within a datacenter, multiple data centers, a peer network, etc. In some cases, one or more of the described system components represents many such components each performing some or all of the function for which the component is described. In some cases, the components can be physical or virtual devices.

Example computing system 1300 includes at least one processing unit (CPU or processor) 1310 and connection 1305 that couples various system components including system memory 1315, such as read-only memory (ROM) 1320 and random access memory (RAM) 1325 to processor 1310. Computing system 1300 can include a cache 1312 of high-speed memory connected directly with, in close proximity to, or integrated as part of processor 1310.

Processor 1310 can include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, etc. Computing system 1300 can also include output device 1335, which can be one or more of a number of output mechanisms. In some instances, multimodal systems can enable a user to provide multiple types of input/output to communicate with computing system 1300. Computing system 1300 can include communications interface 1340, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1330 can include software services, servers, services, etc., that when the code that defines such software is executed by the processor 1310, it causes the system to perform a function. In some aspects, a hardware service that performs a particular function can include the software component stored in a computer-readable medium in connection with the necessary hardware components, such as processor 1310, connection 1305, output device 1335, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1: An apparatus for foveated sensing, the apparatus comprising: a first image sensor and a first optical system aligned relative to a first optical axis; a second image sensor and a second optical system aligned relative to a second optical axis, the second optical axis being different from the first optical axis, wherein the first optical system is associated with a first spatial resolution that is different from a second spatial resolution associated with the second optical system; at least one memory; and at least one processor coupled to the at least one memory and configured to: obtain, from the first image sensor, a first image of a scene, wherein the first image comprises a full region including a fovea region and a peripheral region, the peripheral region being different than the fovea region; obtain, from the second image sensor, a second image of the scene, wherein the second image comprises the fovea region; and generate a combined image, wherein the combined image comprises a first plurality of pixels associated with the fovea region of the scene and a second plurality of pixels associated with associated with a peripheral region of the scene, wherein the second plurality of pixels is generated from pixel values of the first image.

Aspect 2: The apparatus of Aspect 1, further comprising a beam splitter, wherein the beam splitter is configured to split a first portion of light from the scene along the first optical axis and a second portion of light from the scene along the second optical axis.

Aspect 3: The apparatus of any one of Aspects 1 or 2, wherein the full region and the peripheral region are concentric.

Aspect 4: The apparatus of any one of Aspects 1 to 3, wherein the second optical system provides a variable spatial resolution.

Aspect 5: The apparatus of any one of Aspects 1 to 4, further comprising: a first ISP configured to process the first image from the first image sensor; and a second ISP configured to process the second image from the second image sensor.

Aspect 6: The apparatus of Aspect 5, wherein the first ISP and the second ISP process the first image and the second image, respectively, in parallel.

Aspect 7: The apparatus of any one of Aspects 1 to 6, wherein an ISP is configured to process the first image from the first image sensor and to process the second image from the second image sensor.

Aspect 8: The apparatus of any one of Aspects 1 to 7, wherein the at least one processor is further configured to: determine, based on at least one of the first image or the second image, an adjusted fovea region; and adjust the second optical system in accordance with the adjusted fovea region.

Aspect 9: The apparatus of Aspect 8, wherein adjusting the second optical system in accordance with adjusted the fovea region comprises adjusting the second spatial resolution associated with the second optical system.

Aspect 10: The apparatus of Aspect 9, wherein the adjusted fovea region extends outside of the fovea region and is off-center relative to the second optical axis; and adjusting the second spatial resolution associated with the second optical system comprises decreasing a magnification of the second optical system to include the adjusted fovea region.

Aspect 11: The apparatus of any one of Aspects 8 to 10, wherein determining the adjusted fovea region comprises detecting an object based on an image classification and adjusting the fovea region to include the object.

Aspect 12: The apparatus of any one of Aspects 8 to 11, wherein determining the adjusted fovea region comprises detecting local motion in a portion of the scene based on motion detection and adjusting the fovea region to include the portion of the scene.

Aspect 13: The apparatus of any one of Aspects 1 to 12, wherein the at least one processor is further configured to: determine, based on at least one of the first image or the second image, an adjusted fovea region, wherein the adjusted fovea region is off-center relative to the second optical axis; and obtain, from a third image sensor, based on the adjusted fovea region, a third image of the scene, wherein the second image comprises the adjusted fovea region, wherein the third image sensor is different from the first image sensor and the second image sensor.

Aspect 14: The apparatus of any one of Aspects 1 to 13, wherein the first image sensor is configured to capture images at a first frame rate and the second image sensor is configured to capture images at a second frame rate, the first frame rate being slower than the second frame rate.

Aspect 15: The apparatus of any one of Aspects 1 to 14, wherein generating the combined image comprises upscaling the peripheral region from the first image and combining the second image with the upscaled peripheral region from the first image.

Aspect 16: The apparatus of Aspect 15, wherein generating the combined image comprises blending the fovea region from the second image with the first image.

Aspect 17: A method for foveated sensing, the method comprising: obtaining, from a first image sensor, a first image of a scene, wherein the first image comprises a full region including a fovea region and a peripheral region, the peripheral region being different than the fovea region, wherein the first image sensor is associated with a first spatial resolution; obtaining, from a second image sensor, a second image of the scene, wherein the second image comprises the fovea region and wherein the second image sensor is associated with a second spatial resolution, the second spatial resolution being different from the first spatial resolution; and generating a combined image, wherein the combined image comprises a first plurality of pixels associated with the fovea region of the scene and a second plurality of pixels associated with associated with a peripheral region of the scene, wherein the second plurality of pixels is generated from pixel values of the first image.

Aspect 18: The method of Aspect 17, the first spatial resolution is associated with a first optical system; the first optical system and the first image sensor are aligned relative to a first optical axis; the second spatial resolution is associated with a second optical system, the second optical system being different from the first optical system; and the second optical system and the second image sensor are aligned relative to a second optical axis, the second optical axis being at least partially different from the first optical axis.

Aspect 19: The method of Aspect 18, wherein a beam splitter is configured to split a first portion of light from the scene along the first optical axis and a second portion of light from the scene along the second optical axis.

Aspect 20: The method of any one of Aspects 18 to 19, wherein the full region and the peripheral region are concentric.

Aspect 21: The method of any one of Aspects 18 to 20, wherein the second optical system provides a variable spatial resolution.

Aspect 22: The method of any one of Aspects 18 to 21, wherein: a first ISP is configured to process the first image from the first image sensor; and a second ISP is configured to process the second image from the second image sensor.

Aspect 23: The method of Aspect 22, wherein the first ISP and the second ISP process the first image and the second image, respectively, in parallel.

Aspect 24: The method of any one of Aspects 18 to 23, wherein an ISP is configured to process the first image from the first image sensor and to process the second image from the second image sensor.

Aspect 25: The method of any one of Aspects 18 to 24, further comprising determining, based on at least one of the first image or the second image, an adjusted fovea region and adjusting the second optical system in accordance with the adjusted fovea region.

Aspect 26: The method of Aspect 25, wherein adjusting the second optical system in accordance with adjusted the fovea region comprises adjusting the second spatial resolution associated with the second optical system.

Aspect 27: The method of Aspect 26, wherein: the adjusted fovea region extends outside of the fovea region and is off-center relative to the second optical axis; and adjusting the second spatial resolution associated with the second optical system comprises decreasing a magnification of the second optical system to include the adjusted fovea region.

Aspect 28: The method of any one of Aspects 25 to 27, wherein determining the adjusted fovea region comprises detecting an object based on an image classification and adjusting the fovea region to include the object.

Aspect 29: The method of any one of Aspects 25 to 28, wherein determining the adjusted fovea region comprises detecting local motion in a portion of the scene based on motion detection and adjusting the fovea region to include the portion of the scene.

Aspect 30: The method of any one of Aspects 18 to 29, further comprising: determining, based on at least one of the first image or the second image, an adjusted fovea region, wherein the adjusted fovea region is off-center relative to the second optical axis; and obtaining, from a third image sensor, based on the adjusted fovea region, a third image of the scene, wherein the second image comprises the adjusted fovea region, wherein the third image sensor is different from the first image sensor and the second image sensor.

Aspect 31: The method of any one of Aspects 18 to 30, wherein the first image sensor is configured to capture images at a first frame rate and the second image sensor is configured to capture images at a second frame rate, the first frame rate being slower than the second frame rate.

Aspect 32: The method of any one of Aspects 18 to 31, wherein generating the combined image comprises upscaling the peripheral region from the first image and combining the second image with the upscaled peripheral region from the first image.

Aspect 33: The method of Aspect 32, wherein generating the combined image comprises blending the fovea region from the second image with the first image.

Aspect 34: A non-transitory computer-readable storage medium having stored thereon instructions which, when executed by one or more processors, cause the one or more processors to perform any of the operations of Aspects 1 to 33.

Aspect 35: An apparatus comprising means for performing any of the operations of Aspects 1 to 33.

What is claimed is:

1. An apparatus for foveated sensing, the apparatus comprising:
a first image sensor and a first optical system aligned relative to a first optical axis;
a second image sensor and a second optical system aligned relative to a second optical axis, the second optical axis being different from the first optical axis, wherein the first optical system is associated with a first spatial resolution that is different from a second spatial resolution associated with the second optical system;
at least one memory; and
at least one processor coupled to the at least one memory and configured to:
obtain, from the first image sensor, a first image of a scene, wherein the first image comprises a full region including a fovea region and a peripheral region, the peripheral region being different than the fovea region;
obtain, from the second image sensor, a second image of the scene, wherein the second image comprises the fovea region; and
generate a combined image, wherein the combined image comprises a first plurality of pixels associated with the fovea region of the scene and a second plurality of pixels associated with associated with a peripheral region of the scene, wherein the second plurality of pixels is generated from pixel values of the first image.

2. The apparatus of claim 1, further comprising a beam splitter, wherein the beam splitter is configured to split a first portion of light from the scene along the first optical axis and a second portion of light from the scene along the second optical axis.

3. The apparatus of claim 1, wherein the full region and the peripheral region are concentric.

4. The apparatus of claim 1, wherein the second optical system provides a variable spatial resolution.

5. The apparatus of claim 1, further comprising:
a first image signal processor (ISP) configured to process the first image from the first image sensor; and
a second ISP configured to process the second image from the second image sensor.

6. The apparatus of claim 1, wherein the at least one processor is further configured to:
determine, based on at least one of the first image or the second image, an adjusted fovea region; and
adjust the second optical system in accordance with the adjusted fovea region.

7. The apparatus of claim 6, wherein adjusting the second optical system in accordance with adjusted the fovea region comprises adjusting the second spatial resolution associated with the second optical system.

8. The apparatus of claim 7, wherein:
the adjusted fovea region extends outside of the fovea region and is off-center relative to the second optical axis; and
adjusting the second spatial resolution associated with the second optical system comprises decreasing a magnification of the second optical system to include the adjusted fovea region.

9. The apparatus of claim 6, wherein determining the adjusted fovea region comprises detecting an object based on an image classification and adjusting the fovea region to include the object.

10. The apparatus of claim 6, wherein determining the adjusted fovea region comprises detecting local motion in a portion of the scene based on motion detection and adjusting the fovea region to include the portion of the scene.

11. The apparatus of claim 1, wherein the at least one processor is further configured to:
determine, based on at least one of the first image or the second image, an adjusted fovea region, wherein the adjusted fovea region is off-center relative to the second optical axis; and
obtain, from a third image sensor, based on the adjusted fovea region, a third image of the scene, wherein the second image comprises the adjusted fovea region, wherein the third image sensor is different from the first image sensor and the second image sensor.

12. The apparatus of claim 1, wherein the first image sensor is configured to capture images at a first frame rate and the second image sensor is configured to capture images at a second frame rate, the first frame rate being slower than the second frame rate.

13. The apparatus of claim 1, wherein generating the combined image comprises upscaling the peripheral region from the first image and combining the second image with the upscaled peripheral region from the first image.

14. The apparatus of claim 13, wherein generating the combined image comprises blending the fovea region from the second image with the first image.

15. A method for foveated sensing, the method comprising:
obtaining, from a first image sensor, a first image of a scene, wherein the first image comprises a full region including a fovea region and a peripheral region, the peripheral region being different than the fovea region, wherein the first image sensor is associated with a first spatial resolution;
obtaining, from a second image sensor, a second image of the scene, wherein the second image comprises the fovea region and wherein the second image sensor is associated with a second spatial resolution, the second spatial resolution being different from the first spatial resolution; and
generating a combined image, wherein the combined image comprises a first plurality of pixels associated with the fovea region of the scene and a second plurality of pixels associated with associated with a peripheral region of the scene, wherein the second plurality of pixels is generated from pixel values of the first image.

16. The method of claim 15, wherein:
the first spatial resolution is associated with a first optical system;
the first optical system and the first image sensor are aligned relative to a first optical axis;
the second spatial resolution is associated with a second optical system, the second optical system being different from the first optical system; and
the second optical system and the second image sensor are aligned relative to a second optical axis, the second optical axis being at least partially different from the first optical axis.

17. The method of claim 16, further comprising determining, based on at least one of the first image or the second image, an adjusted fovea region and adjusting the second optical system in accordance with the adjusted fovea region.

18. The method of claim 17, wherein adjusting the second optical system in accordance with adjusted the fovea region comprises adjusting the second spatial resolution associated with the second optical system.

19. The method of claim 18, wherein:
the adjusted fovea region extends outside of the fovea region and is off-center relative to the second optical axis; and
adjusting the second spatial resolution associated with the second optical system comprises decreasing a magnification of the second optical system to include the adjusted fovea region.

20. The method of claim 16, further comprising:
determining, based on at least one of the first image or the second image, an adjusted fovea region, wherein the adjusted fovea region is off-center relative to the second optical axis; and
obtaining, from a third image sensor, based on the adjusted fovea region, a third image of the scene, wherein the second image comprises the adjusted fovea region, wherein the third image sensor is different from the first image sensor and the second image sensor.
